(19) United States
(12) Patent Application Publication
(10) Pub. No.: US 2005/0097033 A1
(43) Pub. Date: May 5, 2005

(54) Debt management system

(75) Inventors: Eduardo Pretell, Belmont, CA (US); David Bruggeman, San Ramon, CA (US); Yunlong Xue, Pleasanton, CA (US)

Correspondence Address: LERNER AND GREENBERG, PA, P O BOX 2480, HOLLYWOOD, FL, 33022-2480, US

(73) Assignee: E-Loan, Inc.

(21) Appl. No.: 10/891,405

(22) Filed: Jul. 14, 2004

Related U.S. Application Data
(63) Continuation-in-part of application No. 10/611,482, filed on Jul. 1, 2003.

(51) Int. Cl. G06F 17/60

(52) U.S. Cl. 705/38

(57) ABSTRACT

A debt management system includes a financial planning tool that examines a user's mortgages, home equity loans, auto loans, savings, credit cards, and unsecured debt to determine actions that can be taken to improve the user's debt situation. Upon receiving and saving user financial information, the debt management system dynamically recommends the most cost-effective debt management actions available to the user. The recommendations are based upon one or more parameters, such as desired debt management strategy, optimized user-selected financial goals, user credit information, available debt reduction instruments, real time interest rates, and current underwriting guidelines and upon a variety of user-inputted information. The recommendations of the debt management system are monitored and adaptively changed according to changes in the fiscal environment.

### CROSS-REFERENCE TO RELATED APPLICATIONS

This application claims the benefit under 35 U.S.C. 119(e) of U.S. Provisional Application 60/486,982 originally filed Jul. 14, 2003 and is a continuation-in-part of the co-pending U.S. patent application Ser. No. 10/611,482 filed Jul. 1, 2003, the complete disclosures of which are each hereby incorporated by reference herein in their entirety.

### TECHNICAL FIELD

The present invention relates to a method and system for electronic debt management counseling. More particularly, the present invention relates to a debt management advisory method and system for providing a user who desires debt management counseling with the most cost-effective debt management actions available based upon one or more parameters, such as desired debt management strategy, optimized user-selected financial goals, user credit information, available debt reduction instruments, real time interest rates, current underwriting guidelines and upon a variety of user-inputted information.

### BACKGROUND AND RELATED ART

When it comes to debt management, or more specifically to choosing which debt management approach is best, the enormous number of available choices often intimidates and confuses the public. For example, available debt management tools might suggest that an individual member of the public pay extra every month, pay the minimum on one loan in order to focus the payments on another loan, and/or use savings to pay down debt. Many of these options are mutually exclusive and choosing the best option can be difficult for many individuals. Often debt management tools exclusively focus on how to “pay down” or “pay off” the current debt that an individual has, without considering the overall short and long-term fiscal effects on the individual. In fact, all of the previously available electronic debt management approaches lack the ability to find new debt instruments or loans that can improve the individual's overall financial situation.

Those members of the public seeking debt management counseling are often skeptical and hesitant to trust lending companies and banks as these lending organizations may already have a substantial vested interest in the member's unsecured debt, personal loan(s), current mortgage, or current vehicle loan. As such, their financial advice may often be perceived as self-serving or biased and in some cases, even contrary to appropriate fiscal desires of the individual. Additionally, many members of the public are experiencing the ease of using the Internet to accomplish tasks that previously could only be accomplished by leaving the house or office to go to an established “brick and mortar” lending institution.

It is often intimidating to walk into a bank or other lending institution to discuss taking out a personal loan. Additionally, the person seeking the loan must fill out what seems like reams of paperwork, a time-consuming task. Often the loan applicant is also required to provide additional documentation before their loan application will be considered. As a result, the prospective loan applicant is compelled to return to the lending institution multiple times. Each time they return, the applicant must often reestablish the reason for their application and resubmit their financial information.

In recent years, loan advising models have become commonplace via the Internet, allowing users to enter information on-line and obtain loan recommendations. Current models allow the user to enter particular personal financial information in order to compare the user's current mortgage against another, or in order to obtain recommendations regarding a particular loan type. For example, one type of model provides loan advice strictly for mortgages while another provides loan advice for home equity loans. Other types of Internet models provide loan information without utilizing important user financial criteria such as credit ratings or without considering current, real-time interest rates.

Many of the Internet tools dispensing loan advice do not take into account all the options available to the borrower that could satisfy the borrower's need. For example, if the borrower is interested in seeking a loan in order to buy a vehicle, a series of home and vehicle loan products can be considered; these products are different from the products available if the users want cash. Other models fail to consider exactly what type of financial goals the borrower has in mind, i.e., is the borrower seeking to minimize after-tax interest costs, or to keep their total payments at a minimum? None of the available debt management models provide adaptive dynamic recommendations to the individual based in part on self-selected debt management criteria.

It is therefore desirable to have a debt management advisory method and system that receives and saves financial parameters from a user, such as the desired debt management strategy, the purpose of the loan, whether the user owns a home, the user's current loan information, the user's current credit rating, the user's tax rate, the user's rate of return, and the user's credit card and unsecured debt information and processes these saved financial parameters along with current underwriting parameters, performs real-time searches for all applicable loan types, calculates the optimal loan(s), and dynamically suggests recommended debt management actions to the user.

### SUMMARY OF THE INVENTION

The present invention advantageously provides a method and system that compares currently available mortgage, home equity, vehicle, credit card, personal, and unsecured loans and recommends unbiased debt management actions according to the user-selected debt management strategy. For example, the debt management system may recommend the loan or loans with the lowest cost over the period the user wants to consider. A user is prompted for certain debt information such as the purpose of potential debt consolidation loans, whether the user currently owns a home, and other financial information such as whether or not the user has existing loans and what the user's preferred savings scenario, or goal, would be. The method and system then uses real-time credit-based rates and actual underwriting rules to determine the most effective debt management actions for which a user qualifies. Exemplary actions include reorganizing debt using the lowest cost loan(s) available to the user.

The user starts by selecting a desired debt management methodology, which most closely corresponds to the user's financial goals. This methodology may incorporate the reason for needing debt management counseling and which approaches are acceptable to the user. The debt management system may determine whether the user should transfer balances to another account, use savings to pay off debt, and/or get new loans with lower interest rates. If the user does not own a home and the user is seeking to obtain a cash loan or is seeking to purchase, or refinance a vehicle, there is only one type of loan choice for the user and they are directed to the appropriate personal or vehicle loan sections of the host website. The terms “vehicle”, “auto”, “car”, and “automobile” are used interchangeably throughout this document to refer to any type of vehicle and shall define automobiles, motorcycles, or any other device for transporting persons or things. As such, the present invention is not intended to be limited solely to passenger automobile applications. If the user does own a home, or is seeking to purchase a home, the user is asked to complete a series of questions related to their current or desired mortgage(s), desired goal, tax rate, hold period, rate of return, and vehicle loan, for vehicle refinance users or for new vehicle purchasers.

The present invention receives these inputs and seeks to provide the best recommendations corresponding to the initial financial goals of the user. Additionally, the present invention separately provides all recommendations that save the user money over their current situation, such as the lowest cost loans using the goals identified by the user. If the user chooses to “Minimize total payments”, the system seeks to provide a low monthly payment, but also considers the closing costs associated with the loan and mortgage insurance. If the user chooses to “Minimize after-tax interest costs”, the system compares the after-tax interest plus closing costs and mortgage insurance to provide users with the loan that will minimize non-principal payments. The present invention incorporates a real-time rate search using the user's credit score or estimated credit history, as well as other qualifying underwriting criteria such as minimum and maximum loan amounts and loan-to-value ratios, property type, use and property or transaction location. It then uses all this information to calculate and compare the monthly payments and interest costs of every qualifying loan and suggest the optimal loan option(s) and loan(s) to the user.

Users that seek to refinance their home or to obtain cash may receive a mortgage, and/or a home equity loan or line of credit as the recommended debt management action. In addition, vehicle purchase and vehicle refinance users may receive a vehicle loan, mortgage and/or home equity loan or line of credit as the recommended loan option. Users seeking to purchase a home may receive a mortgage or a first and second mortgage combination as the recommended loan options. If the user is looking for a home refinance or a vehicle refinance loan and they cannot save money with a new loan, the user is informed of this and not presented with any loan options.

Features of the invention can be implemented in a variety of ways, including a method, a system, software instructions stored in a computer readable medium such as a CD-ROM, or software stored and maintained on a web server where data associated with the invention may be accessed via browsers on the user's terminals.

In accordance with one aspect of the present invention, a method for recommending debt management actions to a user for improving the user's debt situation is provided. The method includes the steps of requesting from the user debt management optimization criteria to evaluate potential debt management actions, receiving at least one user-selected debt management optimization criteria, and recommending debt management actions for the user based upon the user-selected debt management optimization criteria.

In accordance with another aspect of the present invention, a system is provided for recommending debt management actions to a user associated with a respective user station. The system includes a communications network, a plurality of user stations selectively connected to the communications network, and a server operatively connected to the communications network. The server is configured to transmit a request for a user-selected debt management optimization criteria to the plurality of user stations via the communications network. Each of the user stations is associated with a respective display terminal for displaying a web page. The server, upon receiving a transmittal containing the user-selected debt management optimization criteria, is configured to further recommend at least one debt management action based upon the debt management optimization criteria for the user associated with the user station that sent the transmittal.

In accordance with yet another aspect, the invention includes a machine readable medium having instructions stored thereon for execution by a processor to perform a method of recommending a debt management action to a user based upon user-selected debt management optimization parameters. The method includes the steps of requesting, from the user, a preferred debt management methodology to be used for establishing debt optimization criteria to evaluate potential debt management actions, receiving the user-selected debt optimization criteria, and performing at least one debt management action for the user based upon the user-selected debt optimization criteria.

### BRIEF DESCRIPTION OF THE DRAWINGS

The embodiments of the invention are illustrated by way of example, and not by way of limitation, in the figures of the accompanying drawings in which like reference numerals refer to similar elements. In the drawings:

FIG. 1 is a diagram of an exemplary structure of the system according to one embodiment of the present invention;

FIG. 2 is a flow chart of the process performed by one embodiment of the present invention when interfacing with a user that is not a homeowner;

FIG. 3 is a flow chart of the process performed by one embodiment of the present invention when interfacing with a user that is a homeowner;

FIG. 4 is a diagrammatic illustration of an introductory web page presented on a user's terminal incorporating one embodiment of the present invention;

FIG. 5 is a diagrammatic illustration of an alternate introductory web page presented on a user's terminal incorporating one embodiment of the present invention;

FIG. 6 is a diagrammatic illustration of a web page presented on a user's terminal for a user who is not a homeowner and wishes to obtain cash;

FIG. 7 is a diagrammatic illustration of a web page presented on a user's terminal for a user who is not a homeowner and wishes to purchase a vehicle;

FIG. 8 is a diagrammatic illustration of a web page presented on a user's terminal for a user who is not a homeowner and wishes to purchase a new vehicle from a franchised vehicle dealer;

FIG. 9 is a diagrammatic illustration of a web page presented on a user's terminal for a user who is not a homeowner and wishes to refinance their current vehicle loan;

FIGS. 10A and 10B are diagrammatic illustrations of web pages presented on a user's terminal for a user seeking to obtain a loan in order to purchase a home;

FIGS. 11A and 11B are diagrammatic illustrations of web pages presented on a user's terminal for a homeowner seeking to obtain a loan in order to purchase a vehicle;

FIGS. 12A and 12B are diagrammatic illustrations of web pages presented on a user's terminal for a homeowner seeking to obtain a loan in order to refinance their home;

FIGS. 13A and 13B are diagrammatic illustrations of web pages presented on a user's terminal for a homeowner seeking to obtain a loan in order to refinance their vehicle;

FIGS. 14A and 14B are diagrammatic illustrations of web pages presented on a user's terminal for a homeowner seeking to obtain a loan in order to obtain cash;

FIGS. 15A and 15B are diagrammatic illustrations of web pages presented on a user's terminal requesting information about the user's current loans;

FIG. 16A-16C are diagrammatic illustrations of a web page(s) presented on a user's terminal suggesting the most cost-effective mortgage loans;

FIGS. 17A and 17B are diagrammatic illustrations of web pages presented on a user's terminal suggesting the most cost-effective home equity loans;

FIGS. 18A and 18B are diagrammatic illustrations of web pages presented on a user's terminal suggesting a home equity loan as the borrower's only mortgage;

FIGS. 19A and 19B are diagrammatic illustrations of web pages presented on a user's terminal suggesting an automobile loan;

FIG. 20 is a diagram of an operating environment for a debt management system according to one embodiment of the present invention;

FIG. 21 is a block diagram of the interactivity of the debt management system with a loan advisory system according to one embodiment of the present invention;

FIG. 22 is a flow chart of the process performed by one embodiment of the present invention when interfacing with a user that is seeking debt management counseling;

FIG. 23A is a diagrammatic illustration of an introductory web page presented on a user's terminal incorporating one embodiment of the present invention;

FIGS. 23B and 23C are diagrammatic illustrations of alternate introductory web pages presented on a user's terminal incorporating one embodiment of the present invention;

FIG. 24 is a diagrammatic illustration of a web page presented on a user's terminal for a user seeking debt management counseling regarding unsecured debts;

FIGS. 25A and 25B are diagrammatic illustrations of web pages presented on a user's terminal for a user who is seeking debt management counseling and may have vehicle related debts;

FIGS. 26A and 26B, taken together, form a diagrammatic illustration of a web page presented on a user's terminal for a user who is seeking debt management counseling and may be a homeowner and have property related debts; and

FIG. 27 is a diagrammatic illustration of a web page presented on a user's terminal for a user indicating the projected value over time of the debt management recommendations.

### DETAILED DESCRIPTION

In the following description, numerous specific details are set forth. However, it is understood that embodiments of the invention may be practiced without these specific details. In other instances, well-known structures and techniques have not been shown in detail in order not to obscure the understanding of this description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

The debt management system is a financial planning tool that examines a user's mortgages, home equity loans, auto loans, savings, credit cards, and unsecured debt to determine actions that can be taken to improve the user's debt situation. The user can choose how they want to improve their debt situation by selecting a preferred debt management approach or methodology to be used for establishing debt optimization criteria. Exemplary debt management approaches for a user include: to minimize their total payments, to minimize their after-tax interest, to get out of debt as soon as possible but not use any payment savings realized to pay off other debt, or to get out of debt as soon as possible using any savings to pay off other debt.

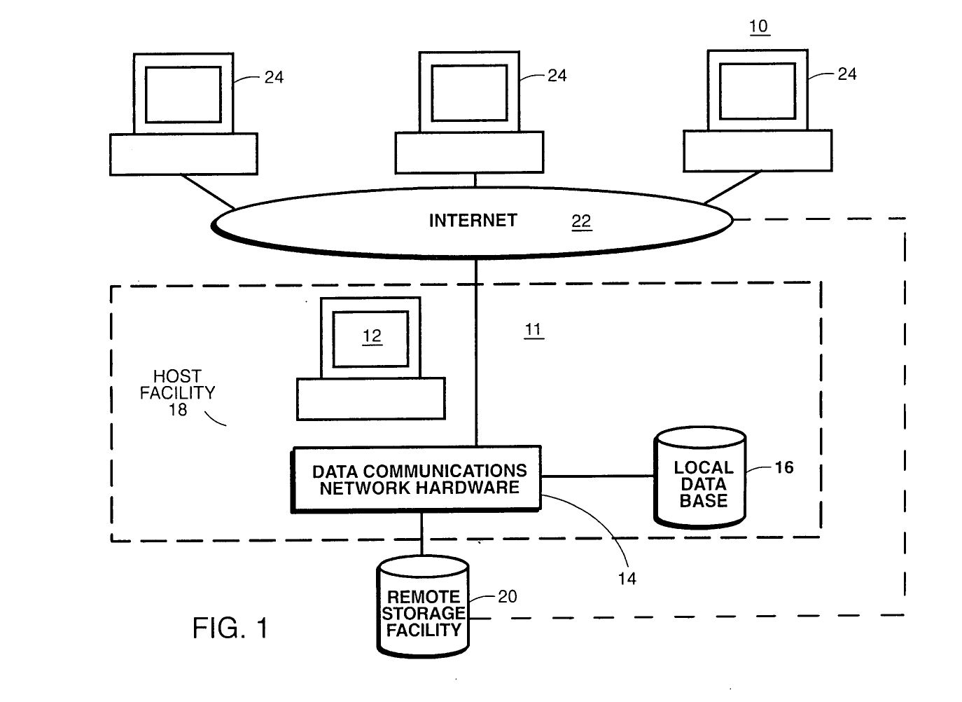

Referring now to the drawing Figures in which like reference designators refer to like elements, there is shown in FIG. 1 an exemplary embodiment of a debt management system constructed in accordance with the principles of the present invention, designated generally with reference numeral 10. The present invention provides a system and method for presenting users with the most cost-effective loans based upon a variety of loan data criteria provided by the user. System 10 includes a debt management server 11 including a database service computer 12 operatively coupled to data communications network hardware 14. Computer 12 may be one or more computers, or network of computers capable of hosting a web site. Computer 12 may be a personal computer, minicomputer, or a mainframe, which offers data management, network administration and security. Network hardware 14 may include one or several processors that host a web site incorporating the present invention as well as standard computer storage components such as Random Access Memory (RAM), Read Only Memory (ROM) and hard disk storage devices, as well as external memory devices such as compact disks, magnetic tape, and the like. Network hardware 14 includes additional processors that process the software instructions housed in the storage components in order to carry out the calculations required to determine the most cost-effective loan options for each user using data stored in a local database 16 and/or a remote information storage facility 20.

The term “server” as used in this application refers to computer 12, network hardware 14, and all software stored thereon. Server 11 stores a variety of web pages that can be accessed by browser software on the user's terminal 24, receive user loan criteria, retrieve information from both local and remote information storage facilities 16, 20, calculate the optimal loan choice for a specific user utilizing a variety of stored algorithms and suggest to the user the optimal loan choice or choices that have been determined.

Electrically coupled to network hardware 14 is local database 16. Database 16 is preferably located within host facility 18, but need not be co-located. Database 16 may store user profile records. These records are created when a user contacts the host website and requests debt management counseling, loan information, loan rates and underwriting guidelines. Among other items, the user is typically asked to provide various levels of financial information to save as user profile records including information concerning a user's unsecured debt, vehicle loans, mortgage or other property loans to be stored in database 16 for future reference by the user. The user is then asked to enter his or her name and a password to identify the user for future login scenarios. Database 16 is preferably any known database system such as a relational or object oriented database system that can be programmed to support the data required to maintain a user listing and to identify the use by their login information.

Remote information storage facility 20 may be operatively coupled to hardware 14 and, in one embodiment, the remote storage facility 20 is accessible via the data communications network 22. Remote storage facility 20 may also be assessable through the data communications network 22, as indicated by the dashed line connecting the two. Remote storage facility 20 may contain certain commercially available financial information such as current interest rates and other consumer-specific data such as a particular user's current loan status of current credit rating. The user's current loan status may include, but is not limited to, such factors as the type of loan(s), the interest rate on the user's current loan(s), the origination date of the loan(s), and the loan term. Information storage facility 20 also includes information regarding available loans including home equity loans, mortgages and automobile loans, and particular underwriting guidelines for each loan option. Alternately, information such as current interest rates, consumer-specific data and other financial information may be stored internally in database 16.

Loan rates are periodically downloaded from remote information storage facility 20 to service server 11, for example, one or more times a day, such that real-time data is used in the analysis that will provide the user with the most cost-effective loan choice. It is well understood that one or more such databases may include what is referred to as information storage facility 20. Facility 20 may include multiple hardware devices such as central processing units (CPUs) and/or storage devices such as CD-ROMs, hard disk drives, or tape drives that can communicate via a communications network. Further, information storage facility 20 may refer to virtually any external information source such as internal proprietary database, external database and online information services from which information may be extracted.

A data communications network 22 couples network hardware 14 to one or more user terminals 24. Network 22 is preferably the Internet, but can be any network capable of communicating data between user terminals 24 and hardware 14. In addition to the Internet, suitable networks may also include or interface with any one or more of, for instance, an local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications network 22 may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. Communications network 22 may yet further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection.

User terminals 24 may represent any type of known computers capable of supporting a web browser, such as Personal Computers (PCs), Personal Digital Assistants (PDAs), such as a Palm Pilot™, a cell phone, or an interactive television. The present invention is not limited by any particular physical communication device and can employ any device that provides interactive access to the Internet. Exemplary user terminals 24 may include, for instance, a personal computer running the Microsoft Windows™ 95, 98, Millenium™, NT™, or 2000, Windows™ CE™, PalmOS™, Unix, Linux, Solaris™, OS/2™, BeOS™, MacOS™, or other operating system or platform. User terminals 24 may also include a microprocessor such as an Intel x86-based device, a Motorola 68K or PowerPC™ device, a MIPS, Hewlett-Packard Precision™, or Digital Equipment Corp. Alpha™ RISC processor, a microcontroller, or other general or special purpose device operating under programmed control. Furthermore, user terminals 24 may include electronic memory such as RAM (random access memory) or EPROM (electronically programmable read only memory), storage devices such as a hard drive, CDROM or rewritable CDROM or other magnetic, optical or other media, and other associated components connected over an electronic bus, as will be appreciated by persons skilled in the art. User terminals 24 may also include a network-enabled appliance such as a WebTV™ unit, radio-enabled Palm™ Pilot or similar unit, a set-top box, a networkable game-playing console such as Sony Playstation™ or Sega Dreamcast™, a browser-equipped cellular telephone, or other TCP/IP client or other device.

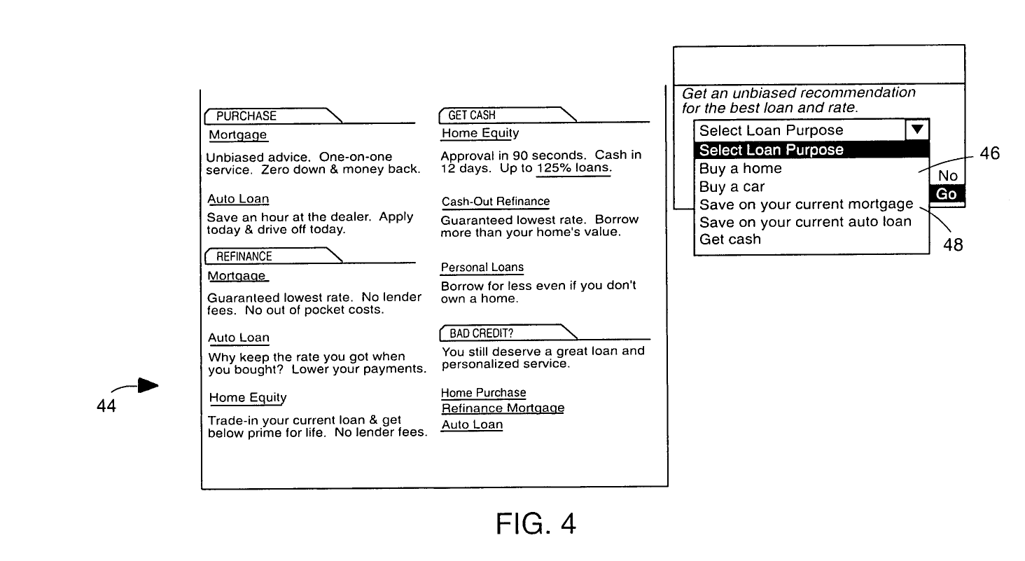

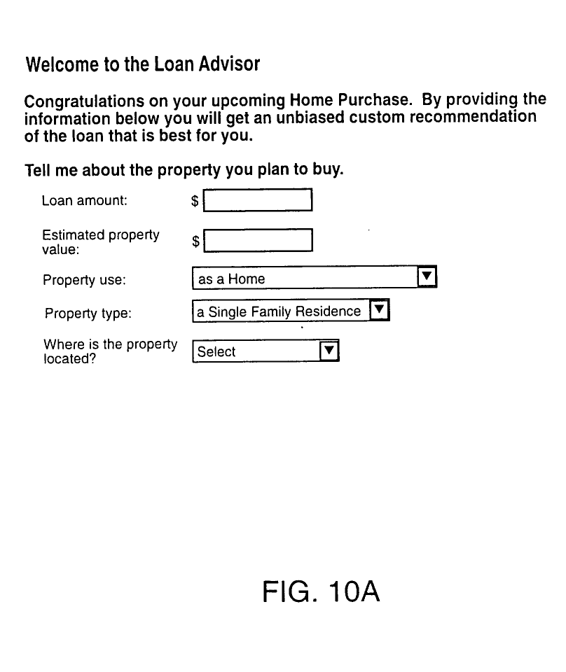

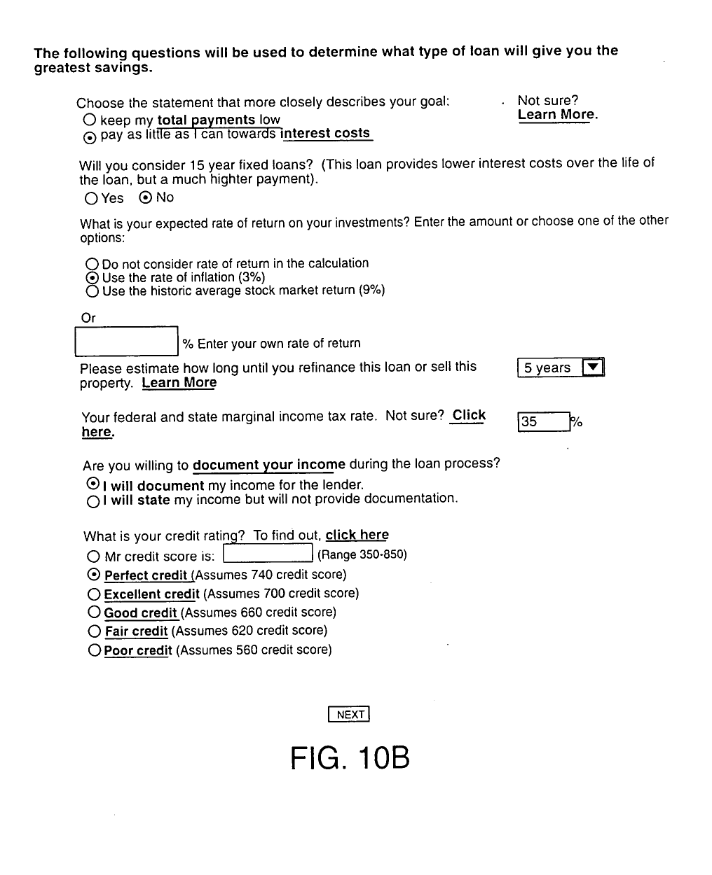

A user electrically contacts the host website supporting the present invention to establish a user profile. The host website creates a user file in database 16. Each user profile preferably includes a user name and corresponding password using the user name and password. A user at user terminal 24 accesses the host website hosted on service computer 12. Firewalls, data encryption, and other hardware and software security measures that are well known in the art may be used to insure that unauthorized users cannot gain access to computer 12. However, any user, including those that have not entered user profile data, may contact the host website and access the debt management counseling system of the present invention. Users wishing to obtain quick, current, and accurate loan guidance are presented with a series of interactive web screens, which guide them through the necessary steps in order to present them with the loan options best suited to the users' requirements. These interactive screens are discussed further below in detail and are illustrated in FIGS. 4 to 19B and FIGS. 23 to 27. Figures with multiple subsections (i.e. FIGS. 10A and 10B) represent either the same screen after the user has scrolled down to view the remainder of the web page or an alternative variation of the same screen based on user input.

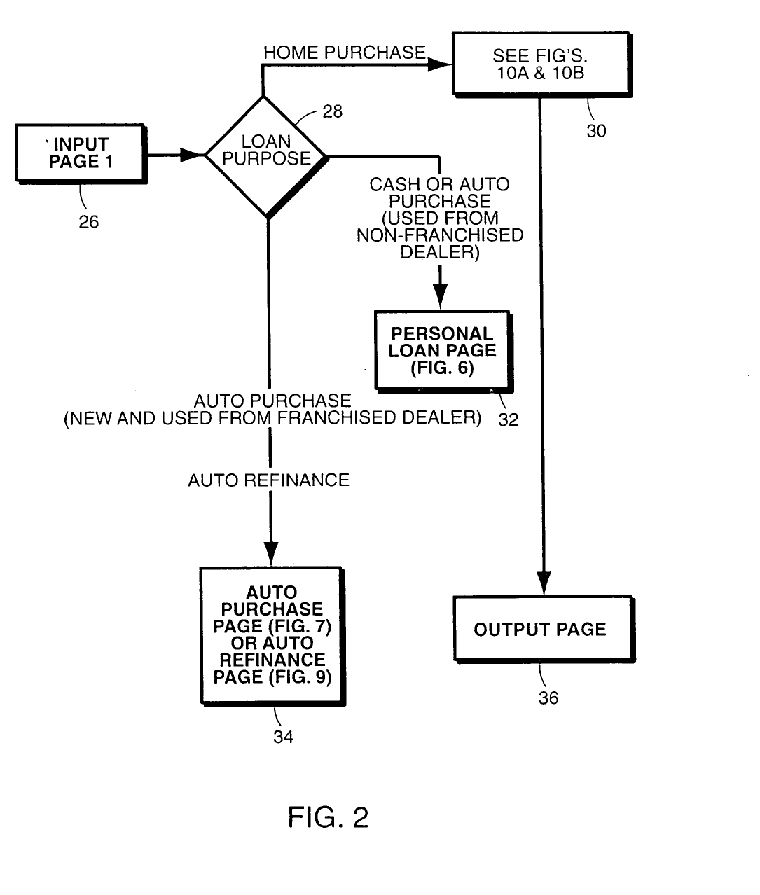

Turning now to FIGS. 2, 3, and 22, particular methods of various embodiments are described in terms of computer software and hardware with reference to a flowchart. The methods to be performed by an electronic device constitute digital logic or computer programs made up of computer-executable instructions. Describing the methods by reference to a flowchart enables one skilled in the art to develop such programs including such instructions to carry out the methods on suitably configured electronic devices (the processor or micro-controller of the computer or game console executing the instructions from computer-accessible media).

The computer-executable instructions may be written in a computer programming language or may be embodied in firmware logic. If written in a programming language conforming to a recognized standard, such instructions can be executed on a variety of hardware platforms and for interfaces to a variety of operating systems. Although not limited thereto, computer software programs for implementing the present method may be written in any number of suitable programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java.™., Jini.™., C, C++, Perl, UNIX Shell, Visual Basic or Visual Basic Script, Virtual Reality Markup Language (VRML), ColdFusion.™. or other compilers, assemblers, interpreters or other computer languages or platforms.

It will be appreciated that a variety of programming languages may be used to implement the debt management system as described herein. Furthermore, it is common in the art to speak of software, in one form or another (e.g., program, procedure, process, application, . . . ), as taking an action or causing a result. Such expressions are merely a shorthand way of saying that execution of the software by an electronic device causes the processor of the computer or game console to perform an action or a produce a result.

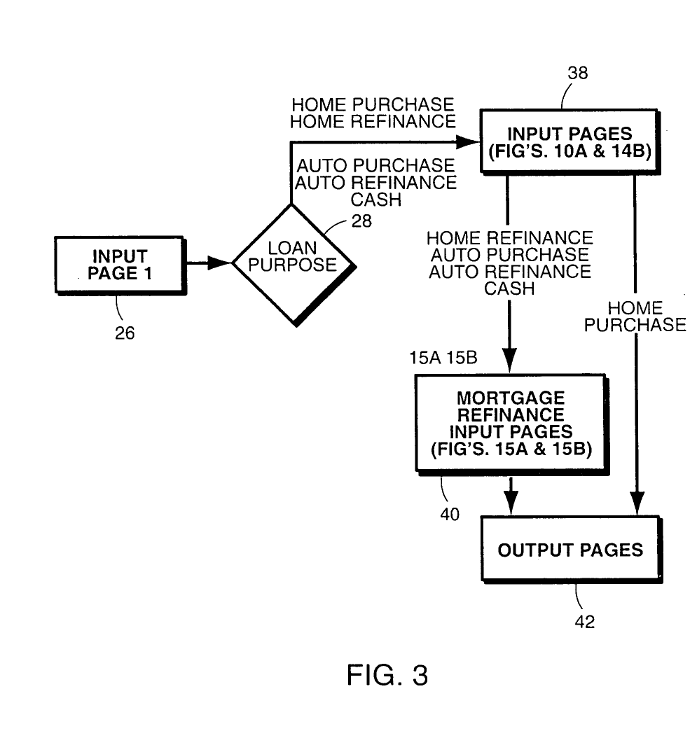

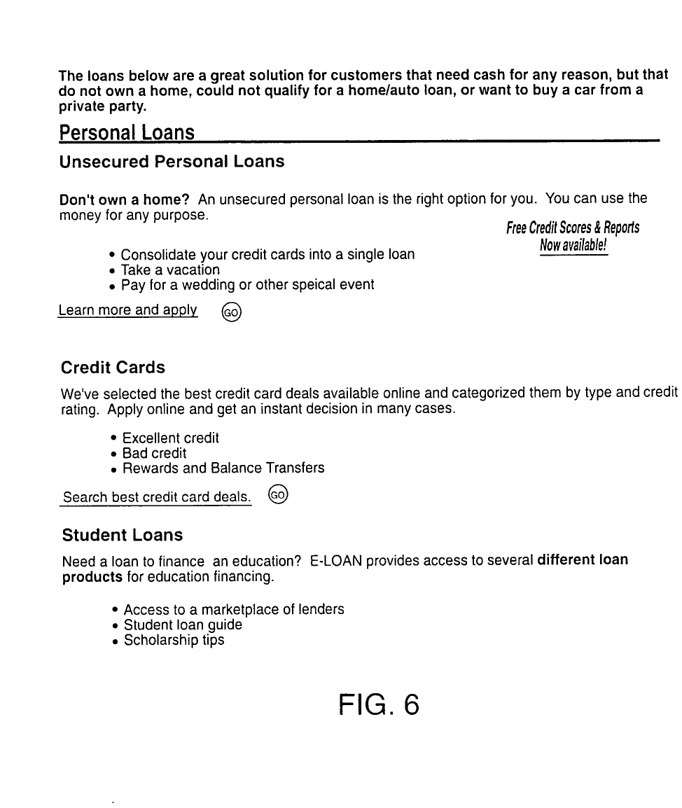

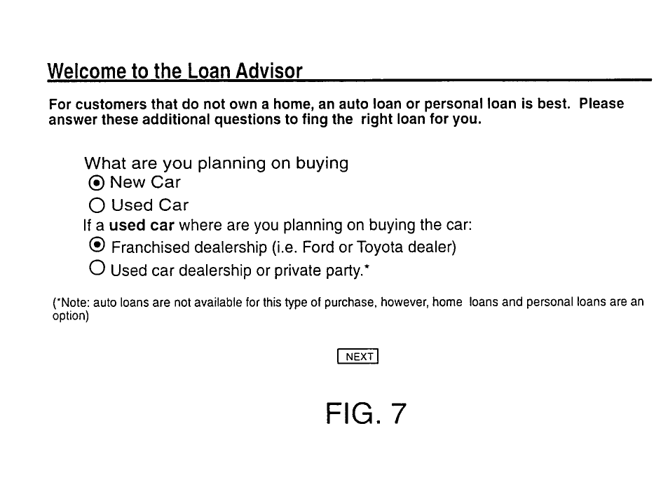

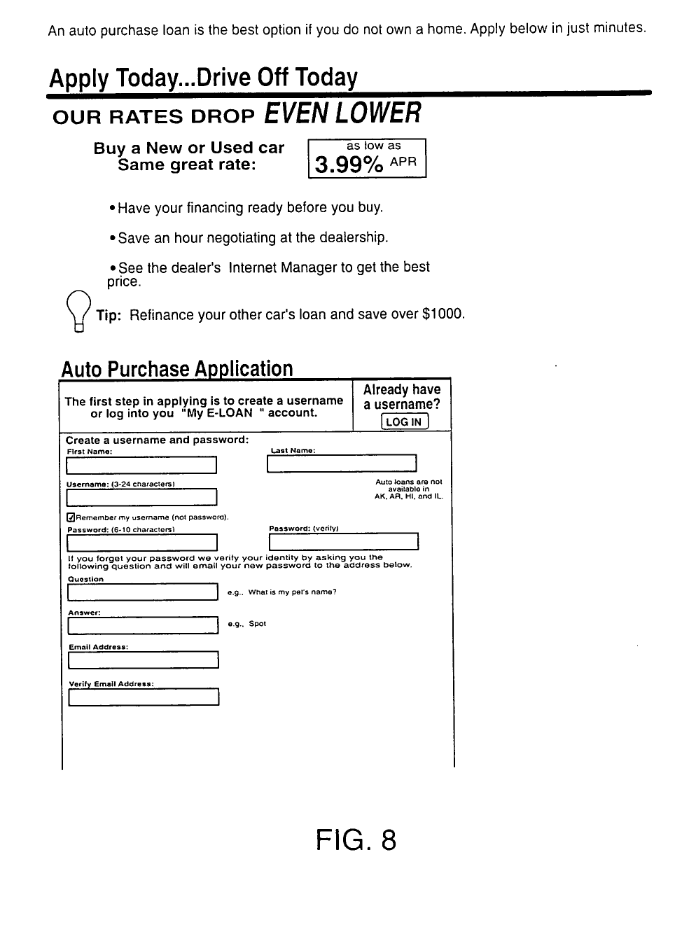

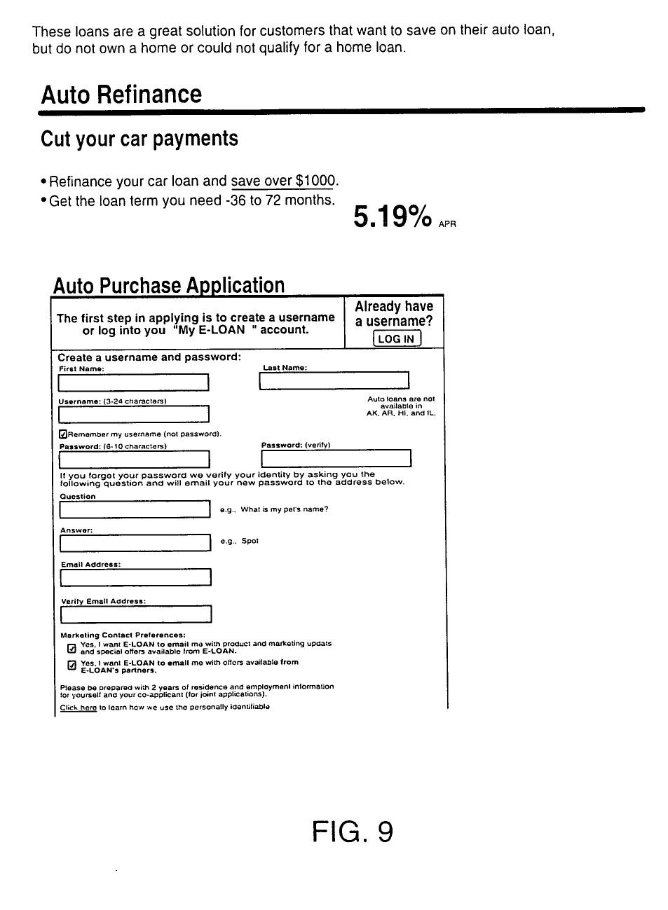

Referring now to FIGS. 2 and 3, flowcharts are presented which illustrate exemplary steps performed by the present invention in determining the optimal loan choice for a suitable user potentially seeking to manage debt through origination or refinancing a loan. The debt management system and method of the present invention takes into account the user's loan purpose as well as other user-supplied and external criteria before calculating the ideal loan or loan choices for the user. At the host website, the user is presented with an input page (step 26) requesting that he or she select a loan purpose (step 28), and to identify whether or not the user is a homeowner. If the user is not a homeowner but wishes to purchase a home, the user is then presented by the system with the web pages shown, for example, in FIGS. 10A and 10B (step 30). If the user is not a homeowner but wants to obtain cash, or wishes to purchase an automobile in a situation where a vehicle loan is not available, the user is presented by the system to the personal loan web page shown, for example, in FIG. 6 (step 32). If the user is not a homeowner and wishes to either purchase a new or used automobile in a situation where a vehicle loan is available or wishes to refinance their existing vehicle loan, the user is directed to the web pages shown, for example, in FIGS. 7 and 9 (step 34), respectively. The screen shown, for example, in FIG. 8 is presented to the user if he or she wishes to obtain a loan for the purchase of a new vehicle in a situation where a vehicle loan is available. Step 36 presents the user that owns a home with web pages recommending the most cost-effective loans.

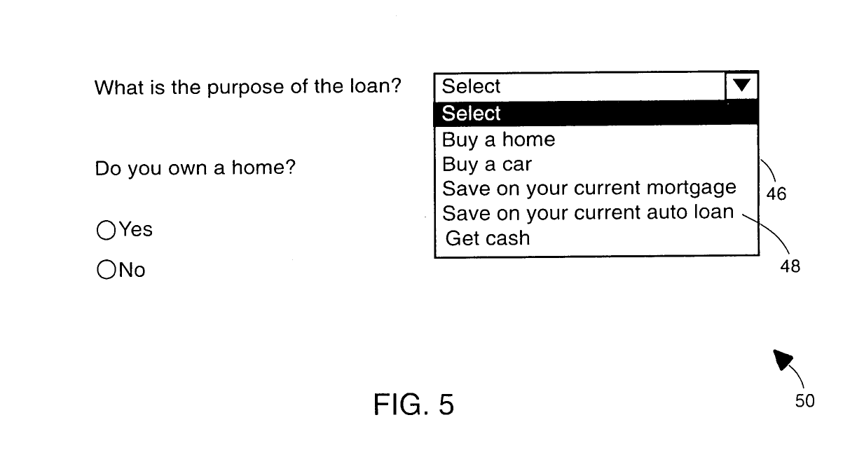

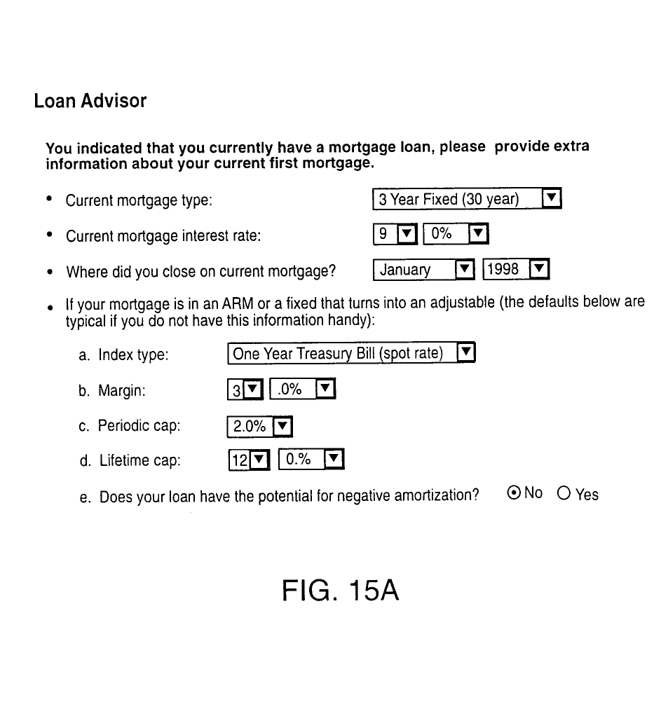

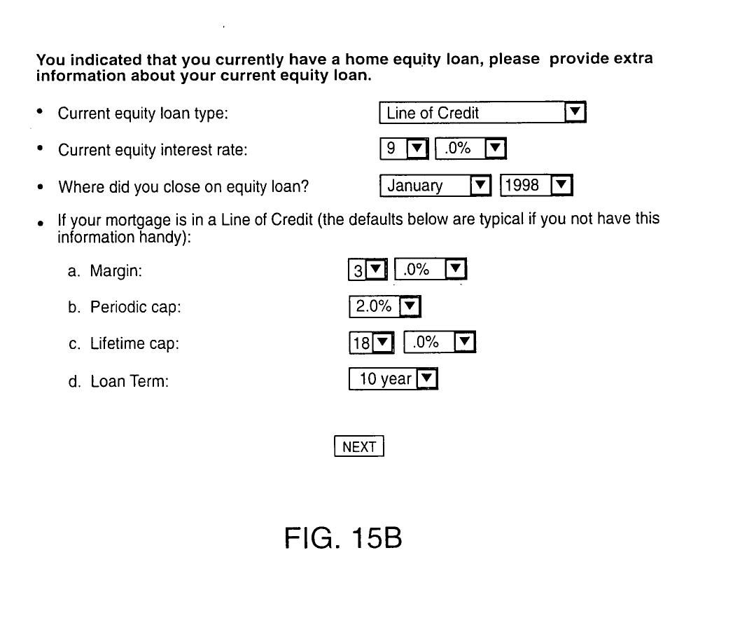

Referring now to FIG. 3, users who indicate that they are homeowners, via the menus shown in FIG. 4 or FIG. 5, are queried as to the purpose of their loan (step 28). Depending upon which loan purpose is selected, the user is presented with one of the input web screens 38 shown in FIGS. 10A through 14B. If the user owns a home and wishes to refinance his or her current mortgage, a new input page 40 is presented to the user, as shown, for example, in FIGS. 15A and 15B. Once server 11 receives the pertinent loan-related information from the user, whether it was supplied initially (from the initial menu) or after a query, other information that may be needed to calculate the most optimal loan for that user is obtained from an external information source, such as remote database 20, and the user is presented with an output page 42. Output page 42 can be one of several different output pages specifically tailored for the type of loan requested. This is explained in detail further below.

Therefore, FIGS. 2 and 3 illustrate the specific steps taken by the present invention in order to determine which loan or loans are most cost-effective to a user. As is shown in step 28, the user's loan purpose is required for optimal loan decisions regardless of whether the user owns a home (FIG. 3) or not (FIG. 2). Once the user's loan purpose is received, various other display screens are presented to the user in order to obtain additional loan-related input parameters, determine which loan is the most cost-effective for the user based upon the user-selected loan purpose and the additional loan-related input parameters, and recommend to the user the most cost-effective loan that is currently available. Some of the loan-related input parameters used in the calculation by the invention may include, but are not limited to, such factors as the user's credit rating, the available loan amount, the loan to value ratio, the combined loan to value ratio, the property type, the property use, and income documentation and location, i.e., the state where the user resides.

While FIGS. 2 and 3 only illustrate one debt management system, several other configurations are acceptable and within the scope of at least one embodiment of the present invention. For example, an embodiment collecting rate information from more than one remote storage facility via the Internet would also benefit from user-selected optimization criteria. Yet another possible configuration uses a direct connection between the user terminals 24 and the server 11. Nor do the embodiments need be limited to non-commercial ventures, thus, in a specialized search, a debt management analysis could also be performed for a corporate entity.

FIG. 4 illustrates a sample home page 44 of host facility 18. This home page is presented on a user's screen as the initial display screen once the user has accessed the host facility web site. In other words, home page 44 is the gateway, which allows users to access the functions provided by system 10. Page 44 includes a loan purpose selection menu 46, which lists a plurality of loan purposes 48. For example, menu 46 may list “Buy a home”, “Buy a car”, “Save on current mortgage”, “Save on current auto loan”, and “Get cash”. The menu 46 depicted on FIG. 4 represents an exemplary embodiment of the present invention. The menu may include less choices or additional choices. It is within the scope of this invention to allow the user to select from a variety of loan purpose options. Alternately, the user may access the loan advisement system of the present invention without entering a choice from menu 46 on home page 44. If the user first chooses to access other information from home page 44, he or she will be prompted with a link to take them to an alternate input screen such as the screen 50 shown in FIG. 5. Once again, a menu is presented to allow the user to choose a loan purpose.

Regardless of which screen the user chooses to access the menu from, he or she is presented with an additional query in addition to the listing of loan purposes. The user must indicate if the user owns a home in order to determine whether mortgages or home equity loans are possible loan options to be considered. As such, the present invention requires that this information be entered in the initial stages of the process. If the user's loan purpose is to obtain cash and the user does not own a home, server 11 presents the user with a web page similar to the one represented in FIG. 6. In this scenario, because the user does not own a home, server 11 does not query the user for any additional information or retrieve any information from external sources. Instead, server 11 presents the user with a choice of possible unsecured loan options. Loan options are not specific loans, but instead are categories of loans that may be of interest to the user. FIG. 6 shows a number of these options. Non-homeowners can get cash with an unsecured loan such as a personal loan or credit card.

If the user does not own a home and indicates a desire to purchase a vehicle, server 11 presents the user with a screen similar to the one shown in FIG. 7. Here, server 11 requires additional loan-related user input parameters to determine the best loan. The user is presented with two queries, namely whether the vehicle the user intends on purchasing is new or used, and whether the vehicle will be purchased from a franchised dealership or a used vehicle dealership or private party. These questions are currently used to determine eligibility for currently available vehicle loan options, but these questions may be dropped, changed, or supplemented as underwriting criteria changes. If the user selects a “new car”, or if the user plans to purchase a vehicle from a franchised dealership, server 11 presents the user with a screen shown in FIG. 8, allowing the user to apply for such a loan. The user is then prompted to enter his or her user name and password in order to apply for an automobile loan directly through the host site. If the user instead elects to purchase a “used car” from a non-franchised dealership (which may be considered an ineligible loan purpose), the user is again presented with the display screen shown in FIG. 6, and unsecured loan options will be presented. Finally, if the non-homeowner user seeks a loan in order to refinance an existing automobile loan, the display screen shown in FIG. 9 is presented to the user. Once again, the user is prompted to enter his or her login account information and can apply for a loan through the host site.

The web screens shown in FIGS. 6 to 9 are presented to users who do not own homes. However, if a user already owns a home or is looking for the best available loan for a new home purchase, server 11 presents the user with an entirely different set of web screen and interactive queries, and the process shown in FIG. 3 is invoked. A user wishing to obtain a loan in order to purchase a new home is presented with the screen shown in FIGS. 10A and 10B. The user is prompted to enter loan-specific details such as the amount of the loan requested, the estimated property value, in what manner the property is going to be used (i.e., primary residence, a second or vacation home, or as an investment), and the state in which the home is or is going to be located. Further, the user is prompted to indicate what the expected rate of return is on the user's investment. For example, the user is asked whether or not they want the expected rate of return to be considered in the calculation and/or whether to use the current inflation rate or to use the historic average stock market return in the calculation. Some or all of these factors are used by server 11 in calculating the best available loan for the user. All of the user's initial input factors are initially used in calculating the optimal loan option. However, some factors, after being considered, may not be used ultimately in the final determination of the qualifying product.

It is noted, the server 11 will not allow the user to navigate beyond the screen shown in FIGS. 10A and 10B until he or she enters additional cost-savings information. In particular, the user must elect whether he or she wishes to minimize the total loan payments or to pay minimal after-tax interest costs. If the user selects the “minimize total payments” option, server 11 searches for loans that provide low monthly fees but will also consider closing costs associated with the loan and mortgage insurance. If the user selects the “minimize after-tax interest cost” option, server 11 compares after-tax interest plus closing costs and mortgage insurance, discounted to account for the time value of money, to provide users with a loan that minimizes non-principal payments. The user is requested to enter additional loan-related information such as how long until the user intends to refinance the loan or sell the property, the user's federal and state income tax rate, the rate of return/inflation the user-wishes to use, and the user's credit rating. If the user does not know their credit rating, the server can retrieve this information from remote information sources, such as database 20.

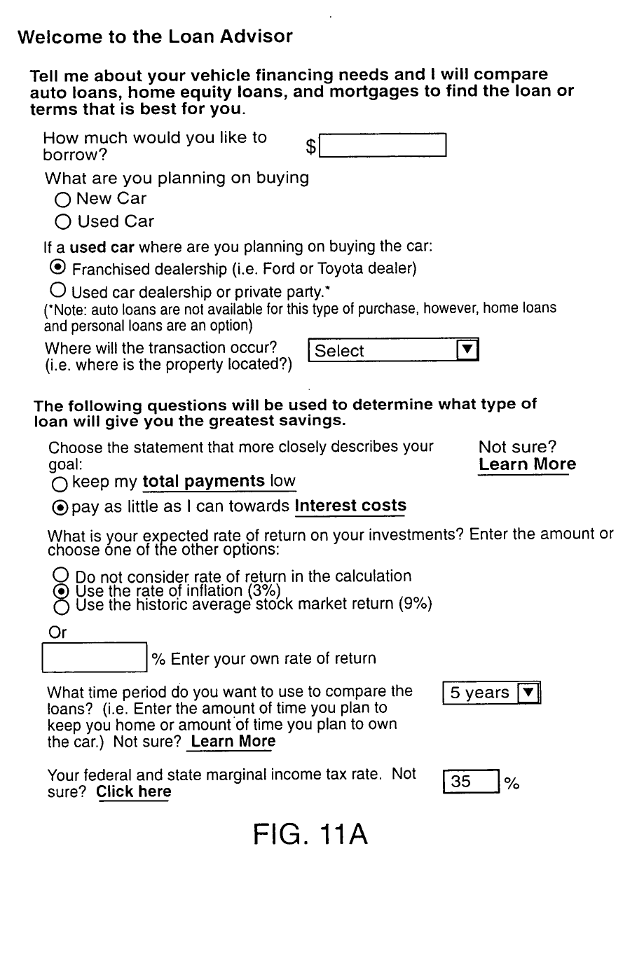

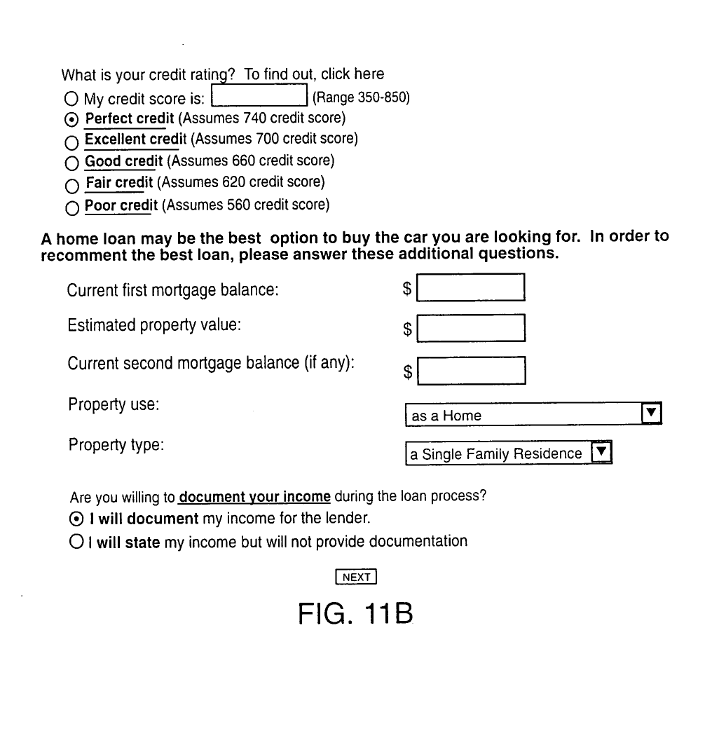

The debt management system 10 of the present invention performs a real-time interest rate search using the loan parameters submitted by the user, including the user's current credit rating, property information, current loan information, and desired loan/amount of cash information to obtain all available loan options. In the case of a new home purchaser, the available loan options may be a mortgage or first and second mortgage combination. For each of the loan options, an optimal loan choice is presented to the user. Server 11 determines the “optimal loan choice” after it has calculated each of the available loans, based upon the user's requirements. The calculations are based upon the algorithms presented below. Server 11 then presents the user with the most affordable loan, based upon the user's preference either to minimize total payments or to minimize after-tax interest payments. If desired, more than one loan choice is presented for each loan option. Similarly, if the user (homeowner) seeks a loan in order to purchase a vehicle, a different screen is presented to the user, such as the screen in FIGS. 11A and 11B. Once again, the user responds to a series of queries and in response, server 11 supplies a list of available loan options, along with the most cost-effective loan choice for each loan option. Again, the “most cost-effective loan choice” is determined after server 11 has determined the cost to the user for each available loan choice, using the algorithms presented below and considering the user's savings preferences.

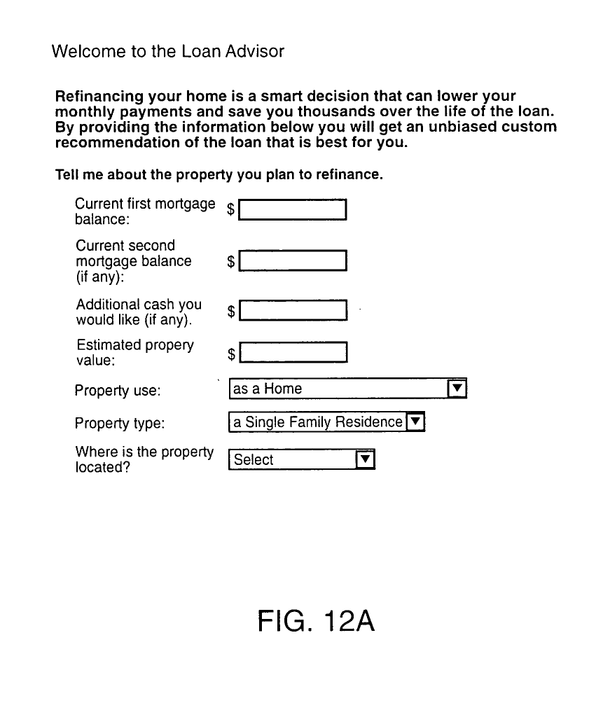

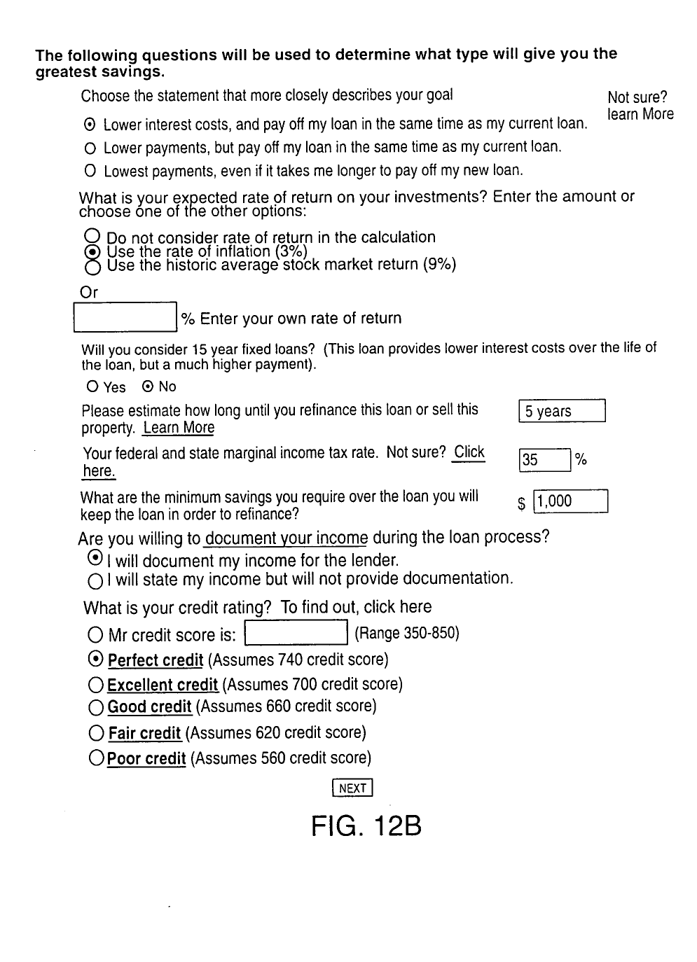

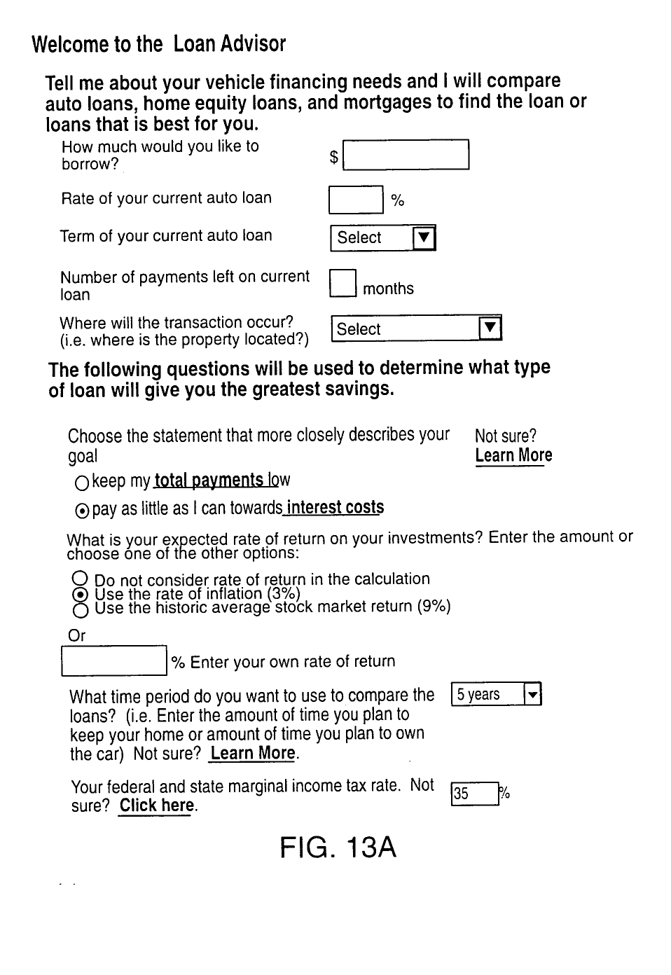

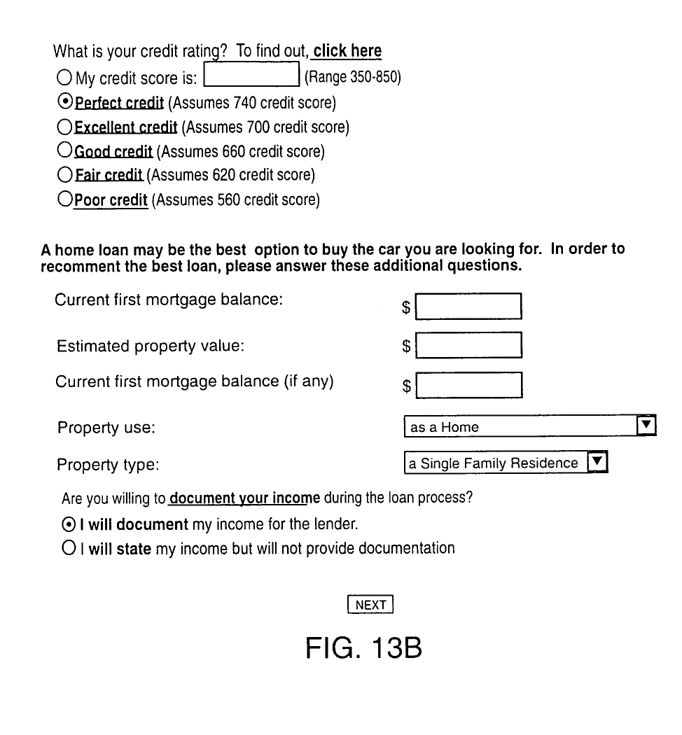

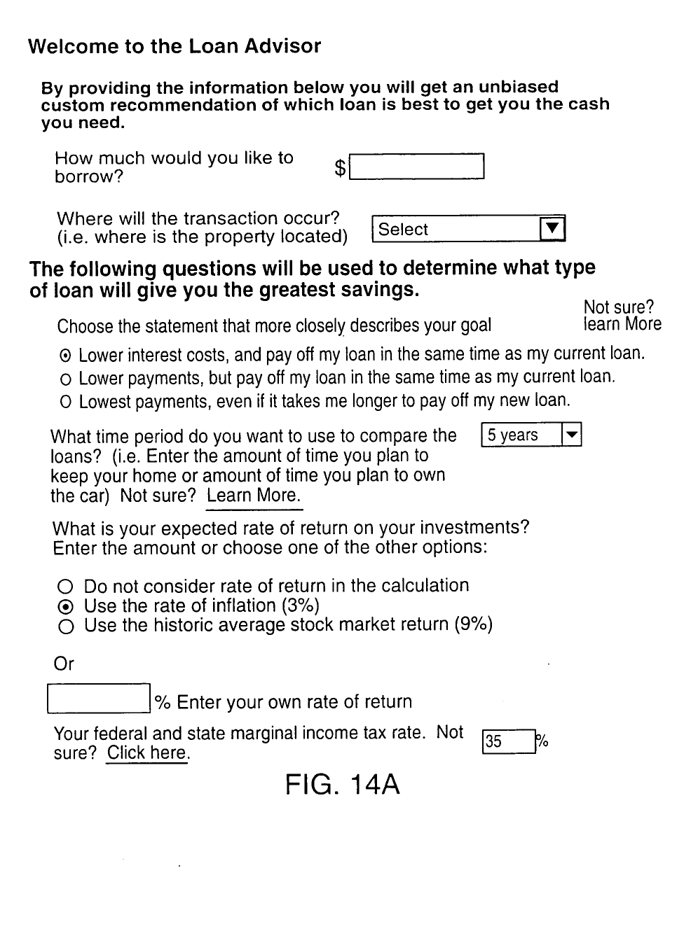

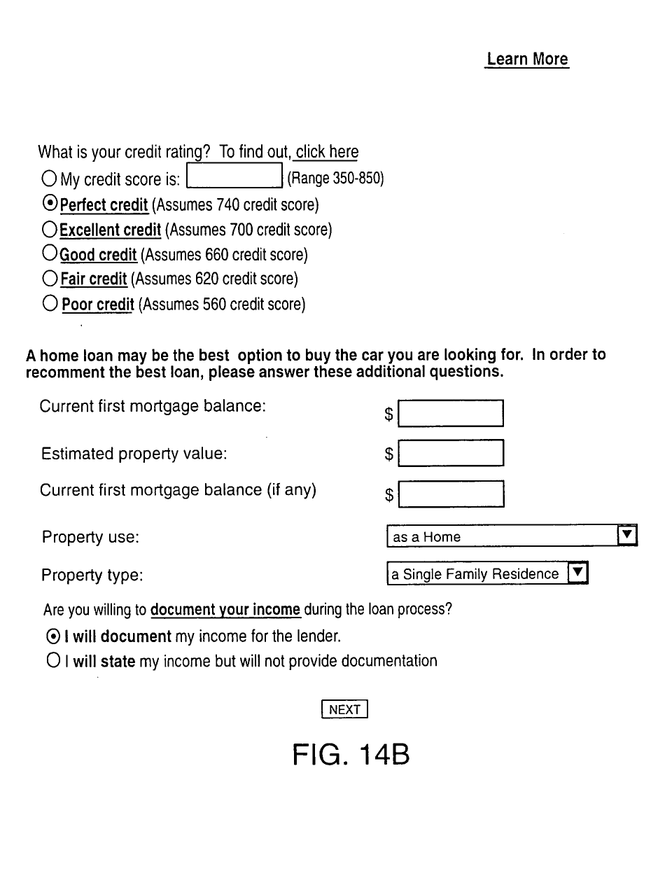

Examination of FIG. 11B reveals an additional query presented to a user who seeks out loan information in order to purchase a new automobile. The user is asked if he or she presently has a mortgage or second mortgage, the type of property, use of the property, and the balance of the loan(s). This information is processed by server 11, along with all other user-specific loan information, and cost-effective loan options and specific loans are presented. Screens presented to users wishing to refinance their homes (FIGS. 12A and 12B), refinance their vehicle loans (FIGS. 13A and 13B), or to obtain cash (FIGS. 14A and 14B) operate in a similar fashion; users are presented with questions and supply answers which are received and processed by server 11. If the user indicates that they already have a mortgage or a home equity loan, the web pages illustrated in FIGS. 15A and 15B, respectively, are presented.

The screens illustrated in FIGS. 12A and 12B are presented to a user who wishes to refinance their homes. Here, the user is asked to indicate what their preferred financial goal is. The user may wish to lower their interest costs and pay off their loan in the same time as their current loan. Alternately, the user may want to lower their payments, but pay off their loan in the same amount of time as their current loan. Finally, the user may opt to lower his/her payments, even if it takes the user longer to pay off the new loan. The present invention is not limited in scope to these specific user goals. The user may be presented with other financial goal options.

In each scenario, information regarding a particular user is received by server 11 via communications network 22, and the information processed by server 11 utilizing information stored in local database 16 and/or remote database 20, and responsive loan-related information is displayed on the user's terminal 24. This responsive information informs the user of the best possible loan currently available, based on the user's financial goals and present financial status, as well as other underwriting factors mentioned above. This is performed by comparing the user's inputs against the underwriting factors to identify all the loans for which the user could qualify. If the user's goal is to minimize total payments, the system will select the loan that has the lowest total combination of monthly payments, closing costs, and mortgage insurance (where relevant) over the requested hold period. If the user's goal is to minimize after-tax interest, the system will select the loan with the lowest present value amount for interest, closing costs, and mortgage insurance (where relevant) combined. In the case where refinancing a loan is being considered, the new loan must offer savings over the current loan.

For users who own a home, there are a number of possible loan options that are presented to the user taking into account the loans the user currently have. For example, if a user wants to save on his/her current vehicle loan, then the possible loan options include: an Auto Refinance to refinance the user's current vehicle loan with a new vehicle loan; a Mortgage Refinance to obtain a cash-out refinance to pay off the current automobile loan; or a Home Equity Loan to obtain a home equity loan to pay off the user's current automobile loan. Other possible loan options that may be presented for a user wanting to save on the current vehicle loan are set forth in the following text, where loans in italics indicate a new suggested loan which may be combined with the user's existing loan:

I. User's Current Loans: Vehicle Loan and Home Equity Possible Loan Options:
Auto Refinance/Home Equity—Refinance the automobile loan with a new automobile loan and keep the current home equity loan;
Home Equity—Get a new home equity loan that pays off the current automobile loan and home equity loan;
Mortgage Refinance—Get a cash-out refinance to pay off the automobile loan and home equity loan;
Balance Transfer—Transferring a balance from one loan to another debt account to pay off the automobile loan and home equity loan; and
Money from Savings—Get cash from savings to pay off the automobile loan and home equity loan.

II. User's Current Loans: Vehicle Loan and Mortgage Possible Loan Options:
Auto Refinance/Mortgage—Refinance the automobile loan with a new automobile loan and keep the current mortgage;
Home Equity—Get a home equity loan to pay off the automobile loan and mortgage;
Mortgage Refinance—Get a cash-out refinance to pay off the automobile loan and mortgage;
Home Equity/Mortgage—Get a home equity loan to pay off the automobile loan and keep the current mortgage;
Balance Transfer—Transferring a balance from one loan to another debt account to pay off the automobile loan and keep the current mortgage; and
Money from Savings—Get cash from savings to pay off the automobile loan.

III. User's Current Loans: Vehicle Loan and Home Equity and Mortgage Possible Loan Options:
Auto Refinance/Home Equity/Mortgage—Refinance the automobile loan and keep the current home equity loan and mortgage;
Home Equity—Pay off all three loans with a home equity loan;
Mortgage Refinance—Pay off all three loans with a cash-out refinance;
Home Equity/Mortgage—Pay off the home equity loan and automobile loan with a home equity loan and keep the current mortgage;
Home Equity/Mortgage—Pay off the current mortgage and vehicle loan with a cash-out refinance and keep the current home equity loan;
Balance Transfer—Transferring a balance from one loan to another debt account to pay off the automobile loan and home equity loan; and
Money from Savings—Get cash from savings to pay off the automobile loan and home equity loan.

IV. User's Current Loans: Vehicle Loan (No Mortgage, but Owns a Home) Possible Loan Options:
Auto Loan—Get an automobile loan to refinance the current vehicle loan;
Home Equity—Get a home equity loan to pay off the current vehicle loan;
Mortgage Refinance—Get a cash-out refinance to pay off the current vehicle loan;
Balance Transfer—Transferring a balance from one loan to another debt account to pay off the automobile loan; and
Money from Savings—Get cash from savings to pay off the automobile loan.

V. User's Current Loans: Unsecured Debt and Personal Loans (No Mortgage, but Owns a Home) Possible Loan Options:
Home Equity—Get a home equity loan to pay off the current unsecured debt;
Mortgage Refinance—Get a cash-out refinance to pay off the unsecured debt;
Balance Transfer—Transferring a balance from one loan to another debt account to pay off a portion of the unsecured debt; and
Money from Savings—Get cash from savings to pay off the unsecured debt.

For a user wishing to purchase a new vehicle or a used vehicle from a franchised dealership or another situation where a vehicle loan is not an option, the following loan options are considered:

VI. User's Current Loans: None (No Mortgage, but Owns a Home) Possible Loan Options:
Auto Loan—Get an automobile loan to buy the vehicle;
Home Equity—Get a home equity loan to buy the vehicle;
Mortgage Refinance—Get a cash-out refinance to buy the vehicle;
Balance Transfer—Transferring a balance from another debt account to buy the vehicle; and
Money from Savings—Get cash from savings to buy the vehicle.

VII. User's Current Loans: Home Equity Possible Loan Options:
Auto Loan/Home Equity—Get an automobile loan to buy the vehicle and keep the current home equity loan;
Home Equity—Get a home equity loan to pay off the current home equity loan and get cash to buy the vehicle;
Mortgage Refinance—Get a cash-out refinance to pay off the current home equity loan and get cash to buy the vehicle;
Balance Transfer—Transferring a balance to another debt account to buy the vehicle; and
Money from Savings—Get cash from savings to buy the vehicle.

VIII. User's Current Loans: Mortgage Possible Loan Options:
Auto Loan/Mortgage—Get an automobile loan to buy the vehicle and keep the current mortgage;
Home Equity—Get a home equity loan to pay off the current mortgage and get cash to buy the vehicle;
Mortgage Refinance—Get a cash-out refinance to pay off the current mortgage and get cash to buy the vehicle;
Home Equity/Mortgage—Get a home equity loan to get cash to buy the vehicle and keep the current mortgage;
Balance Transfer—Transferring a balance to another debt account to buy the vehicle; and
Money from Savings—Get cash from savings to buy the vehicle.

IX. User's Current Loans: Home Equity and Mortgage Possible Loan Options:
Auto Loan/Home Equity/Mortgage—Get an automobile loan to buy the vehicle and keep the current home equity loan and mortgage;
Home Equity—Get a home equity loan to pay off the current home equity and mortgage and get cash to buy the vehicle;
Mortgage Refinance—Get a cash-out refinance to pay off the current home equity and mortgage and get cash to buy the vehicle;
Home Equity/Mortgage—Get a home equity loan to pay off the current home equity, get cash to buy the vehicle, and keep the current mortgage;
Home Equity/Mortgage—Get a mortgage to pay off the current mortgage, get cash to buy the vehicle, and keep the current home equity loan;
Balance Transfer—Transferring a balance to another debt account to buy the vehicle; and
Money from Savings—Get cash from savings to buy the vehicle.

For the scenario in which the user wants to buy a used vehicle from a non-franchised dealership or another situation where a vehicle loan is not an option, the following loan options are available:

X. User's Current Loans: None (No Mortgage, but Owns a Home) Possible Loan Options:
Home Equity—Get a home equity loan to get cash to buy the vehicle;
Mortgage Refinance—Get a cash-out refinance to get cash to buy the vehicle;
Personal Loan—Get a personal loan to get cash to buy the vehicle;
Balance Transfer—Transferring a balance to another debt account to buy the vehicle; and
Money from Savings—Get cash from savings to buy the vehicle.

XII. User's Current Loans: Home Equity Possible Loan Options:
Home Equity—Get a home equity loan to pay off the current home equity loan and get cash to buy the vehicle;
Mortgage Refinance—Get a cash-out refinance to pay off the current home equity and get cash to buy the vehicle;
Personal Loan/Home Equity—Get a personal loan to get cash to buy the vehicle and keep the current home equity loan;
Balance Transfer—Transferring a balance to another debt account to buy the vehicle; and
Money from Savings—Get cash from savings to buy the vehicle.

XIII. User's Current Loans: Mortgage Possible Loan Options:

Home Equity—Get a home equity loan to pay off the current mortgage and get cash to buy the vehicle;
Mortgage Refinance—Get a cash-out refinance to pay off the current mortgage and get cash to buy the vehicle;
Home Equity/Mortgage—Get a home equity loan to get cash to buy the vehicle and keep the current mortgage;
Personal Loan/Mortgage—Get a personal loan to get cash to buy the vehicle and keep the current mortgage;
Balance Transfer—Transferring a balance to another debt account to buy the vehicle; and
Money from Savings—Get cash from savings to buy the vehicle.

XIV. User's Current Loans: Home Equity and Mortgage Possible Loan Options:
Home Equity—Get a home equity loan to pay off the current mortgage and home equity loan and get cash to buy the vehicle;
Mortgage Refinance—Get a cash-out refinance to pay off the current mortgage and home equity loan and get cash to buy the vehicle;
Home Equity/Mortgage—Get a home equity loan to pay off the current home equity, get cash to buy the vehicle, and keep the current mortgage;
Personal Loan/Home Equity/Mortgage—Get a personal loan to get cash to buy the vehicle and keep the current home equity loan and mortgage;
Home Equity/Mortgage—Get a cash-out refinance to pay off the current mortgage, get cash to buy the vehicle, and keep the current home equity loan;
Balance Transfer—Transferring a balance to another debt account to buy the vehicle; and
Money from Savings—Get cash from savings to buy the vehicle.

Yet another scenario is where the user who has no current loans seeks a loan in order to purchase a house; for that user the following loan options are available:

XV. User's Current Loans; N/A Possible Loan Options: New Loans:
Mortgage—Buy the house with a new mortgage.
Mortgage/Home Equity—Buy the house with a new mortgage and home equity loan.

If a user already owns a house and wants a loan to reduce his or her current mortgage payments, the following loan options are available:

XVI. User's Current Loan: Mortgage Possible Loan Options:
Home Equity—Pay off the current mortgage with a new home equity loan.
Mortgage Refinance—Pay off the current mortgage with a mortgage.

XVII. User's Current Loans: Home Equity and Mortgage Possible Loan Options:
Home Equity—Pay off both the current mortgage and home equity loan with a new home equity loan.
Mortgage Refinance—Pay off both the current mortgage and home equity loan with a new mortgage.
Home Equity/Mortgage Refinance—Pay off the current mortgage and keep the current home equity loan.

Finally, if the user wants to obtain cash, the following are the loan options that will be presented to the user, depending upon the user's current loans:

XVIII. User's Current Loans: None (No Mortgage, but Owns a Home) Possible Loan Options:
Home Equity—Get cash with a home equity loan.
Mortgage Refinance—Get cash with a cash-out refinance.
Personal Loan—Get cash with a personal loan.
Balance Transfer—Drawing cash from another debt account.
Money from Savings—Get cash from savings.

XIX. User's Current Loans: Home Equity Possible Loan Options:
Home Equity—Pay off the current home equity with a new home equity and get cash.
Mortgage Refinance—Pay off the current home equity with a cash-out refinance and get cash.
Personal Loan/Home Equity—Get a personal loan to get cash and keep the current home equity loan.

XX. User's Current Loans: Mortgage Possible Loan Options:
Home Equity—Pay off the current mortgage with a home equity loan and get cash.
Mortgage Refinance—Pay off the current mortgage with a cash-out refinance and get cash.
Home Equity/Mortgage—Get a home equity to get cash and keep the current mortgage.
Personal Loan/Mortgage—Get a personal loan to get cash and keep the current mortgage.

XXI. User's Current Loans: Home Equity and Mortgage Possible Loan Options:
Home Equity—Pay off the current home equity and mortgage with a home equity loan and get cash.
Mortgage Refinance—Pay off the current home equity and mortgage with a cash-out refinance and get cash.
Home Equity/Mortgage—Pay off the current home equity with a new home equity loan, get cash, and keep the current mortgage.
Home Equity/Mortgage—Pay off the current mortgage with cash-out refinance, get cash, and keep the current home equity loan.
Personal Loan/Home Equity/Mortgage—Get cash with a personal loan and keep the current home equity and mortgage.

Once the various possible loan options are determined, the processor within server 11 of the present invention utilizes specific algorithms to determine which loans will save the user the most money by calculating the cost over a period of time that is specified by the user. If the user's goal is to minimize total payments, the present invention adds closing costs, principal, interest, and mortgage insurance, such as PMI, if applicable, paid over the specified period of time. If the user's goal is to minimize after-tax interest, then the system of the present invention adds interest, closing costs, and, if applicable, mortgage insurance. Points and interest (for home loans up to 100% of the property value) are adjusted for taxes in the “minimize after-tax interest” scenario. Points are tax deductible in year one for Purchase loans and over the life of the loan for Refinance and Home Equity loans. Multiplying the tax rate the user provided by the amount of interest and points paid determines the tax adjustment. This methodology is applied to both the user's current loans and new loans.

The algorithms used by the debt management system 100 of the present invention discern the type of loan the user is seeking and then apply a distinct algorithm for that loan purpose. For example, automobile loans have a fixed interest rate; therefore, there is no need to obtain an interest rate forecast from an exterior information source. The following calculation for automobile loans applies for all loan uses, i.e. new, used, and refinanced vehicle loans and is distinguished by the user's choice of goal. The server performs the calculation below for all available loans and determines which would provide the lowest cost to the user, where “lowest cost” varies depending upon the user's chosen savings goal.

Loan Amount=amount of money the user wants to borrow

T=term of the loan

IR=investment rate

Minimize Total Payment Option:

Calculate the sum of:
(payments in year one)+(payments in year two)/(1+IR)+ . . . +(payments in year T)/(1+IR)\hat{ }T

Minimize After-Tax Interest Option:

Calculate the Sum of:
(interest portion of the payments in year one)+(interest portion of the payments in year two)/(1+IR)+ . . . +(interest portion of the payments in year T)/(1+IR)\hat{ }T

Home equity loans generally have a fixed interest rate at least for a long period, so, once again; no interest rate forecast is needed. Home equity lines of credit are typically based on an index such as the prime rate. Since the prime rate is a variable rate, it will have to be forecast into the future so the line of credit interest rate can be forecast. The present invention uses the current treasury yield curve and adds an adjustment figure, such as 3.0%, as a margin to the treasury yield curve to derive a prime rate yield curve. This prime rate yield curve is then adjusted by the chosen margin to determine the line of credit interest rate. The calculation set forth in the following text applies to all home equity products including lines of credit and fixed loans.

Loan Amount=amount of money the user wants to borrow+balance of current second mortgage OR amount of money the user wants to borrow+balance of current first and second mortgage

T=term of the loan

N=time frame the user will be keeping the loan

IR=investment rate

Minimize Total Payment Option:

Calculate the Sum of:
(closing costs+points+payments in year one)+(payments in year two)/(1+IR)+ . . . +(payments in year N)/(1+IR)\hat{ }N

Minimize After-Tax Interest Option:

Calculate the Sum of:
(interest portion of the payments in year one )*(1-tax rate)+closing costs+points−(points/T* tax rate)+(interest portion of the payments in year two)*(1-tax rate)−(points/T* tax rate)/(1+IR)+ . . . +(interest portion of the payments in year N)*(1-tax rate)−((T−N)/T* points*tax rate)/(1+IR)\hat{ }N

Mortgages may have a fixed rate or a variable rate. If the mortgage has a fixed interest rate, then no interest rate forecast is needed. If the mortgage has a variable rate, then the interest rate will have to be forecast into the future. The current treasury yield curve is used and then adjusted by the margin to determine the mortgage rate. The calculation set forth in the following text applies to all mortgage products including Adjustable Rate Mortgages (ARMs) and fixed loans, for purchase, refinance, and refinance loans with cash out options.

T=term of the loan

N=time frame the user will keep the loan

IR=investment rate

Minimize Total Payment Option: (Taxes are not Part of the Calculation)

Calculate the Sum of:
(closing costs+points+payments in year one)+(payments in year two)/(1+IR)+ . . . +(payments in year N)/(1+IR)\hat{ }N

Minimize After-Tax Interest Option:

Refinance:

Calculate the Sum of:
(interest portion of the payments in year one)*(1-tax rate)+closing costs+points−(points/T* tax rate)+(interest portion of the payments in year two)*(1-tax rate)−(points/T* tax rate)/(1+IR)+ . . . +(interest portion of the payments in year N)*(1-tax rate)−((T−N)/T*points*tax rate)/(1+IR)\hat{ }N

Purchase:

Calculate the Sum of:
(interest portion of the payments in year one+points)*(1-tax rate)+closing costs+(interest portion of the payments in year two)*(1-tax rate)/(1+IR)+ . . . +(interest portion of the payments in year N)*(1-tax rate)/(1+IR)\hat{ }N

If the loan advisory system 10 of the present invention chooses a mortgage as the optimal loan option, it will suggest to the user the best loan in each of up to three loan categories to accommodate the differences in user risk preference and tolerance. The user may choose how many loans in each category he or she wishes to see. For example, the system will suggest “Recommended Loan”, which is the least conservative category. Under this loan category, the system will display the loan with the greatest savings without excluding any loan types. Interest-only loans, loans with a prepayment penalty and home equity loans in place of a first mortgage are all evaluated. A second loan category that is suggested to the user does not consider loans with a pre-payment penalty, interest-only payments, and home equity loans as the only mortgage, even if they were to yield the lowest cost. This loan category is considered “More Conservative” and is not displayed if the “Recommended Loan” already meets the extra criteria. A third category that may be presented to a user if a mortgage is selected as one of the loan options is the “More Conservative, Fixed Rate Loan” category. This category goes one step further and eliminates adjustable rate mortgages from the consideration set. It will show the lowest-cost, fixed-rate, “traditional” mortgage. This category is not displayed if the “Recommended Loan” or “More Conservative Loan” categories already satisfy the extra criteria. The various loan categories are presented to users to account for different levels of acceptable user risk.

If the loan advisory system of the present invention determines that the optimal loan option is a home equity loan such that the user will keep their current first mortgage, both the lowest cost home equity loans and lines of credit will be presented to the user. Finally, if automobile loans are suggested, and in consideration of the fact that automobile loans have no closing costs, only rates and terms distinguish one automobile loan from one another. As a result, all automobile loans are displayed if an automobile loan option is recommended.

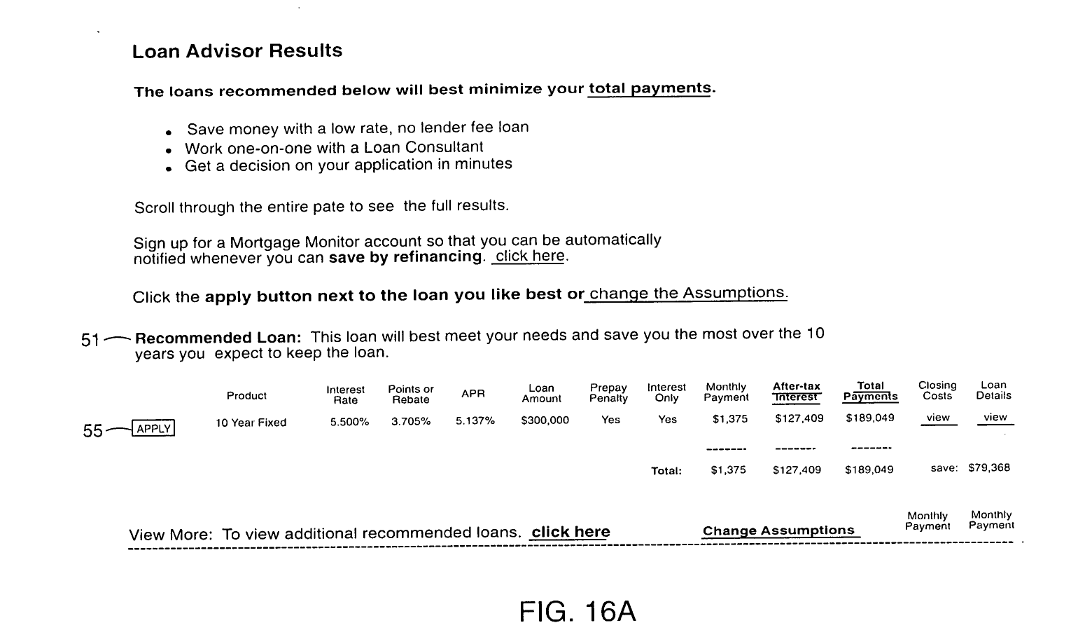

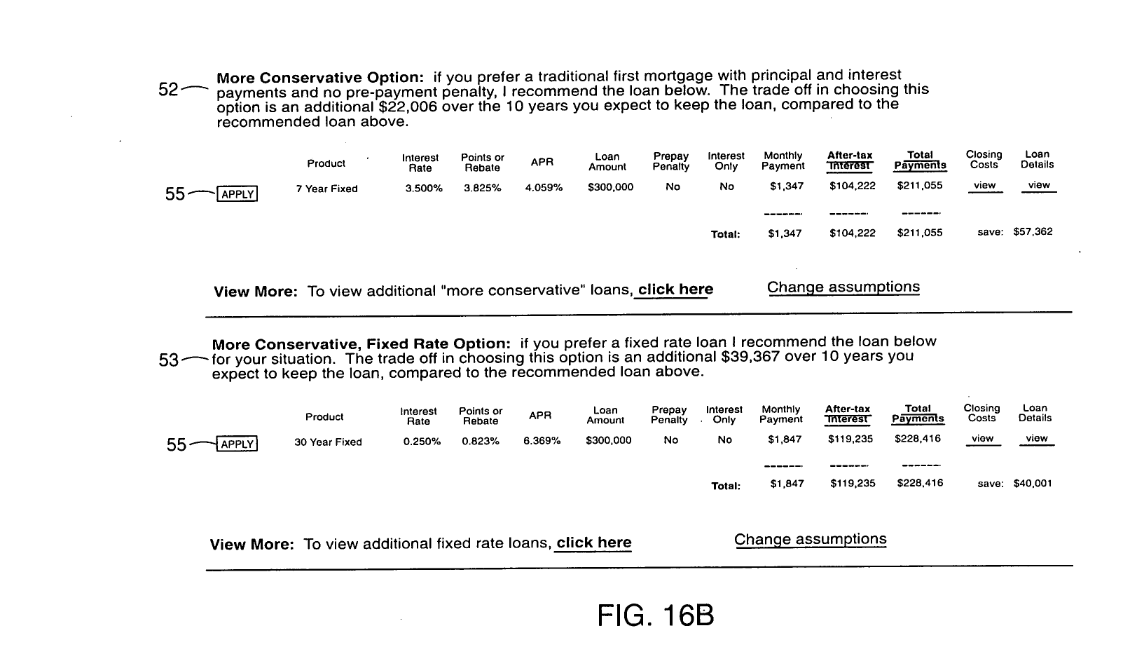

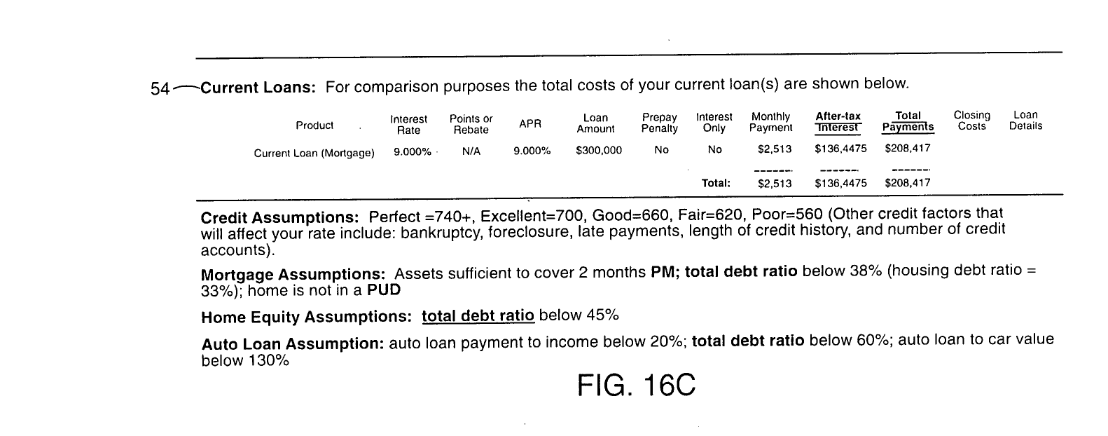

FIGS. 16A through 19B refer to output web pages that are presented to the user after the loan advisory system of the present invention has calculated the optimal loan options and loans for a particular user. FIGS. 16A-16C illustrate an exemplary web page presented to a user that recommends a mortgage. Each of the three mortgage categories recommended take into consideration the user's choice of minimizing their total payments. Three mortgage categories are recommended to the user. In FIG. 16A, a Recommended Loan category 51 is presented, which, in this case suggests a 10-year fixed mortgage at an interest rate of 5.5%. At the top of FIG. 16B, a “More Conservative Option” 52 suggests a 7-year fixed rate mortgage at 3.5%. At the bottom of FIG. 16B, a third mortgage category, “More Conservative, Fixed Rate Option” 53 is presented, suggesting a 30-year fixed rate mortgage at 6.25%. FIG. 16C lists the user's current loan 54 as a comparison to the recommended loans. The “APPLY” button 55 allows the user to directly apply for the selected loan.

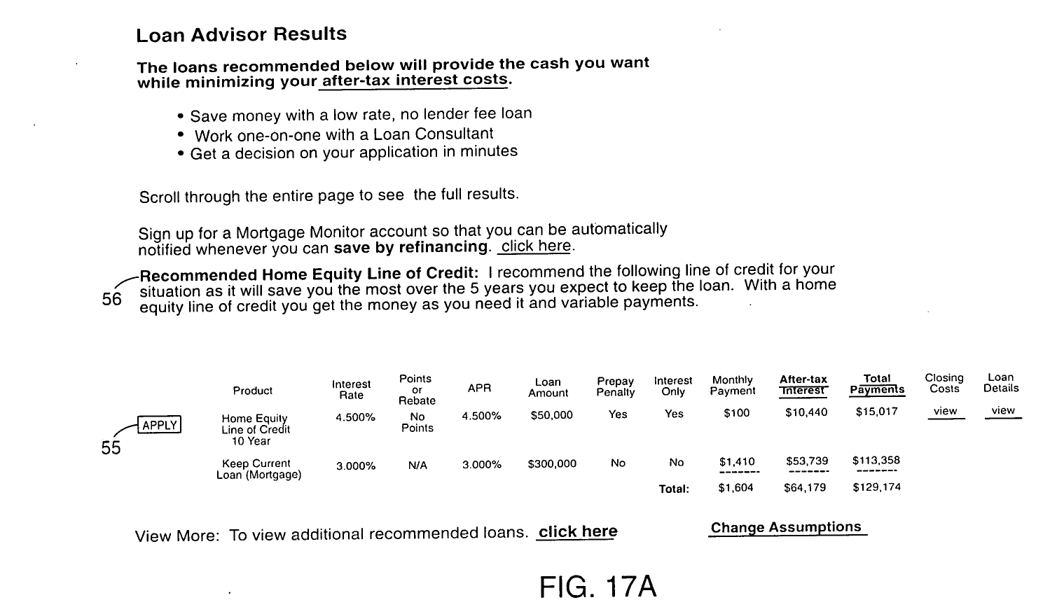

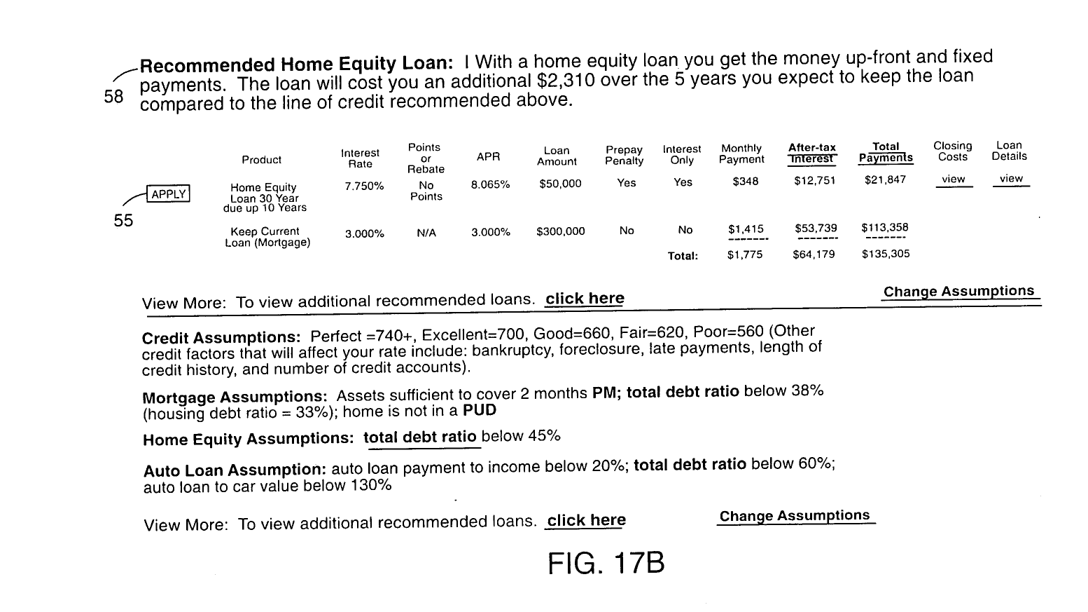

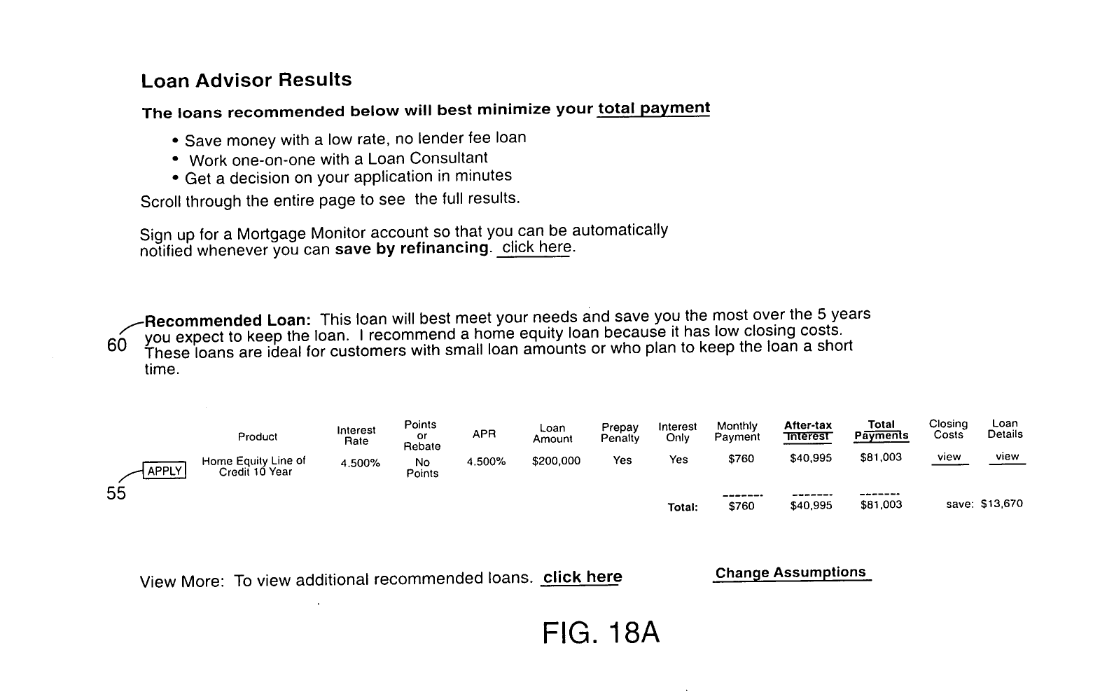

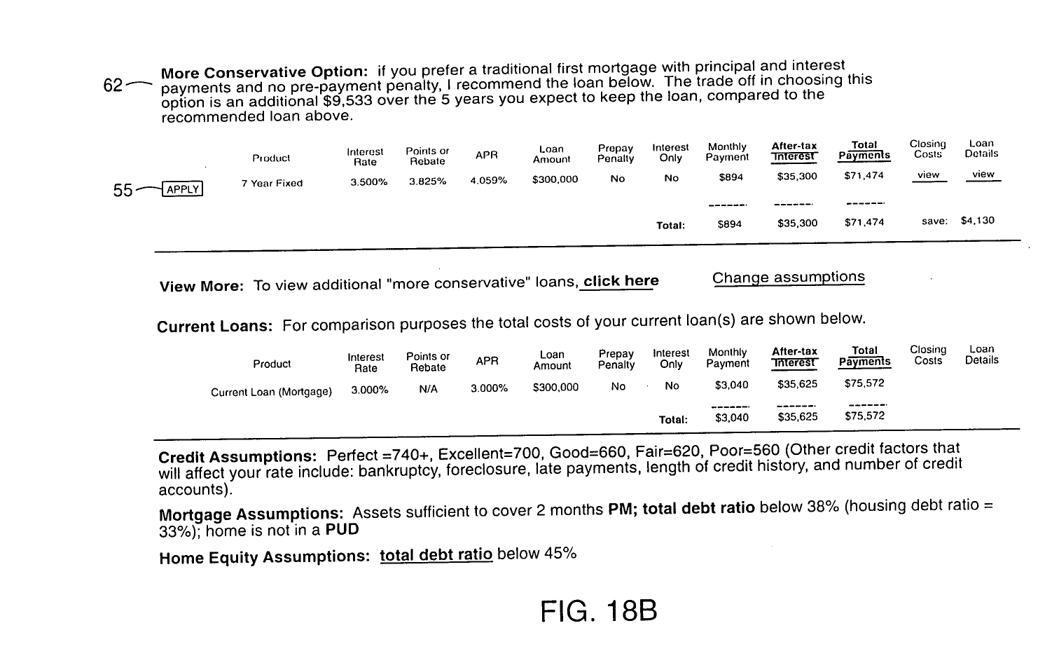

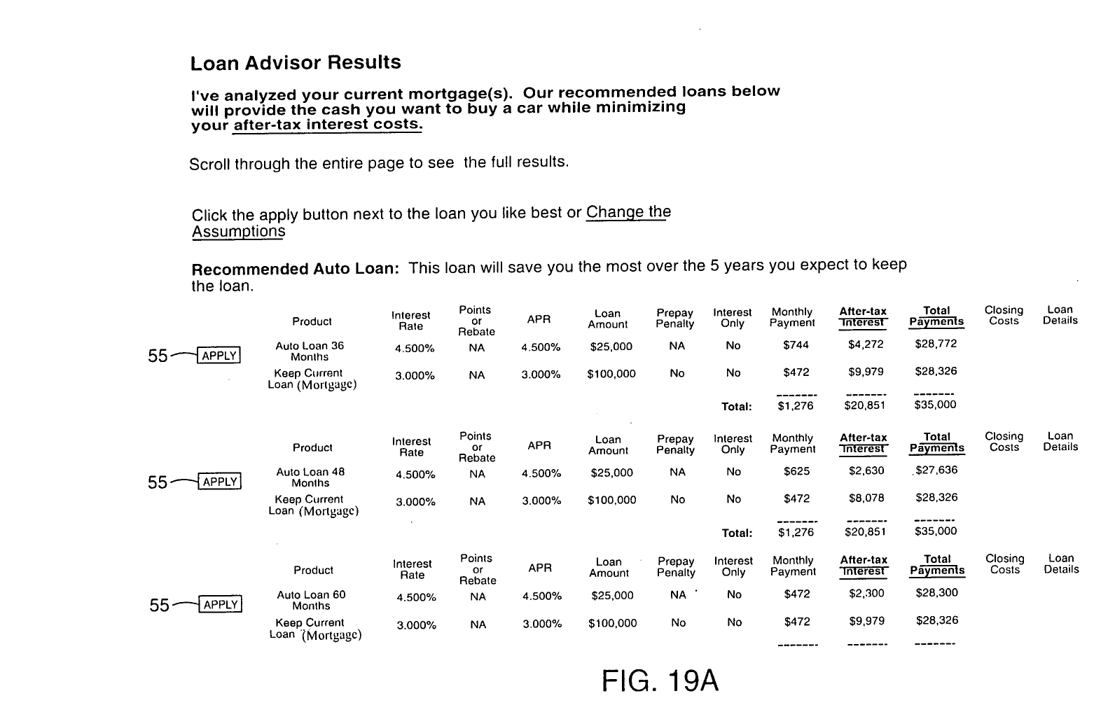

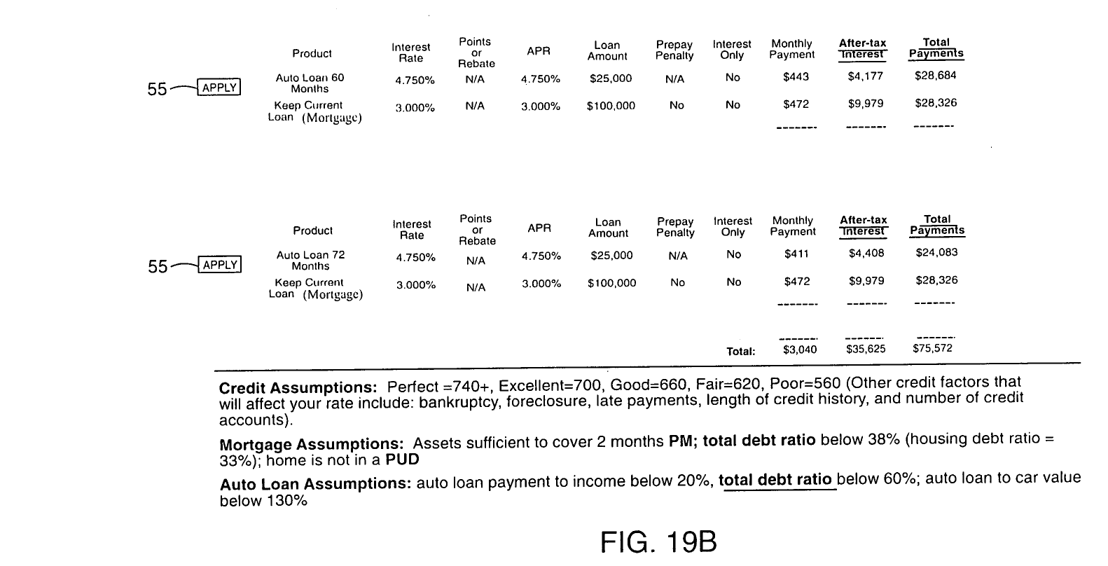

FIGS. 17A and 17B illustrate exemplary output web screens presented to a user who wishes to minimize after-tax interest costs. In this scenario, a home equity line of credit 56 is recommended (FIG. 17A) as well as a home equity loan 58 (FIG. 17B). Other general loan-related information is shown on these pages and include benefits of a home equity loan or line of credit, specifics about the recommended loan such as monthly payment amount, and/or the existence of any prepayment penalties and assumptions that were used to calculate the recommended loan. FIGS. 18A and 18B are exemplary web screens that suggest a home equity loan as the only mortgage. Once again, these figures illustrate results obtained for a user seeking to minimize their total payments. In this scenario, a recommended loan 60 is presented (FIG. 18A), along with a more conservative loan 62 (FIG. 18B). FIGS. 19A and 19B show exemplary output web screens when an automobile loan is recommended and where the user seeks to minimize after-tax interests costs. Here, four automobile loans are recommended, with varying interest rates and loan terms.

It should be noted that, after one or more loans are recommended to a user, the user may choose to apply for one of the recommended loans directly through the host website, via activation of button 55. In this instance, a loan application is presented and the user may enter the information. The host server receives this information and may forward it to the appropriate lending institution for processing.

The present invention provides an interactive loan advisory system and method that provides users with optimal loan choices in a broad range of loan categories based upon a user's specific financial goals and status. The loan advisory system of the present invention obtains real-time loan rates and determines, via a variety of algorithms, the loan or loans that would be most cost-effective to a user, incorporating the user's preferred savings goal. The invention is not restricted to one type of loan category but instead examines a variety of loan categories and, if there is more than one loan option available, presents the user with a recommended loan as well as a more conservative loan option. The invention also allows the user to directly apply for the loan of their choosing.

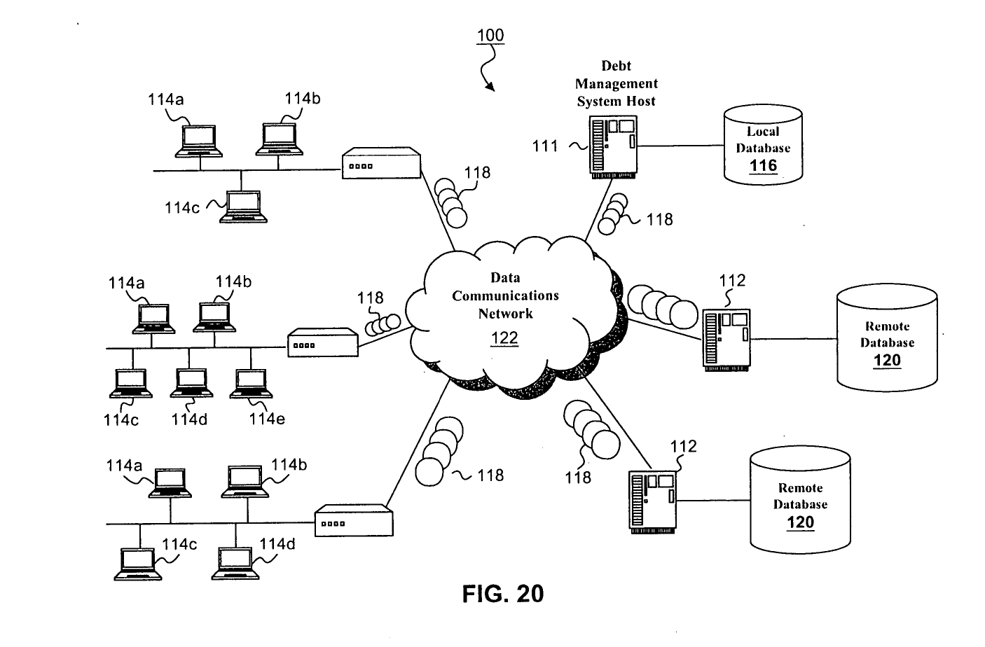

FIG. 20 and the following discussion are intended to provide a brief, general description of a suitable environment 100 that includes a debt management system host 111, multiple remote financial information hosts 112, and a plurality of user terminals 114 exchanging data 118 across data communications network 122. The debt management system host 111 being operatively connected to data communications network 122 and having a local database 116 for storing user profile records. The multiple financial information hosts 112 being operatively connected to the data communications network 112 and each having a remote database 120 for storing real-time financial information, such as mortgage rates and unsecured credit rates. The data communications network 122 is preferably the Internet, but can be any network capable of communicating data between user terminals 114 and the debt management system host 111. The plurality of user terminals 114 is selectively coupled to the data communication network 122.

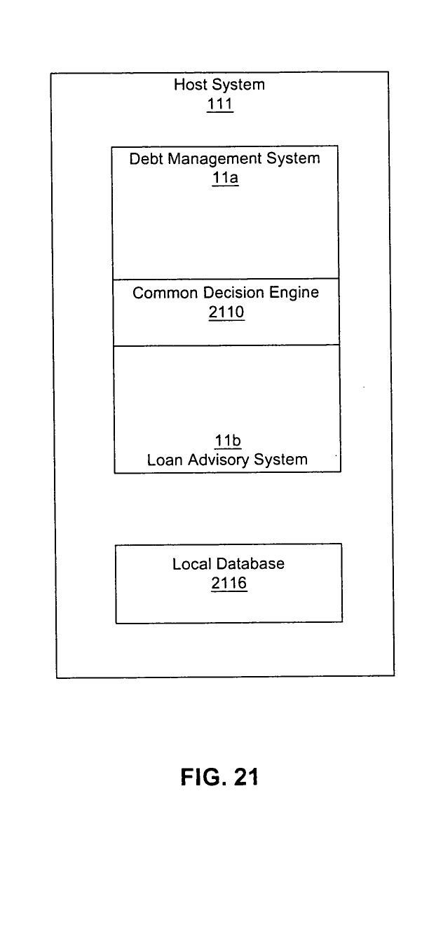

FIG. 21 is a block diagram illustrating the interactivity of a debt management system with a loan advisory system according to one embodiment of the present invention. Host system 111 includes a local database 16 in communication with a debt management system 11a and a loan advisory system 11b. More specifically, the debt management system 11a and the loan advisory system 11b share a common decision engine 2110 for generating the recommended debt management actions and loan suggestions. While not all of the items handled in the host system 111 are shared, the determination of the lowest cost loan options may be employed in both the debt management system 11a and the loan advisory system 11b.

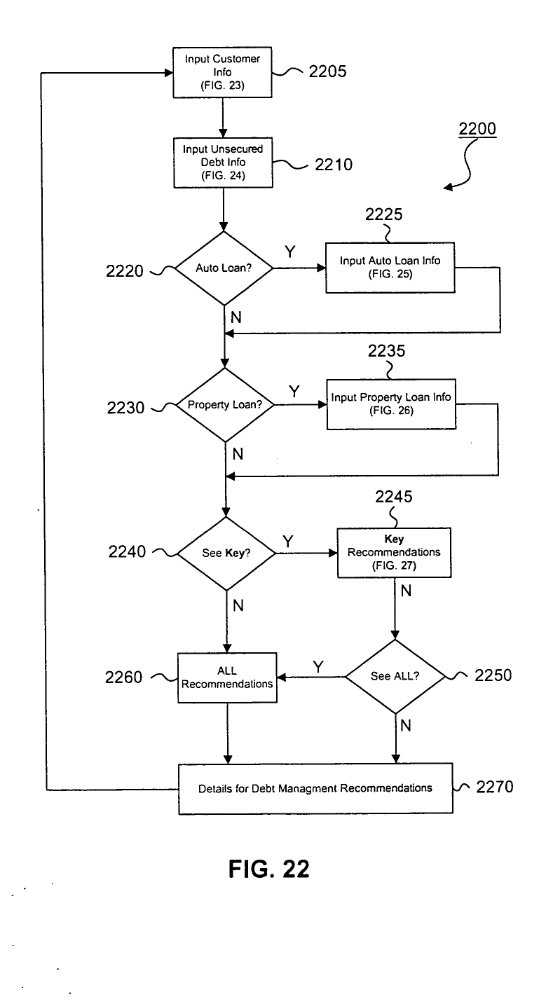

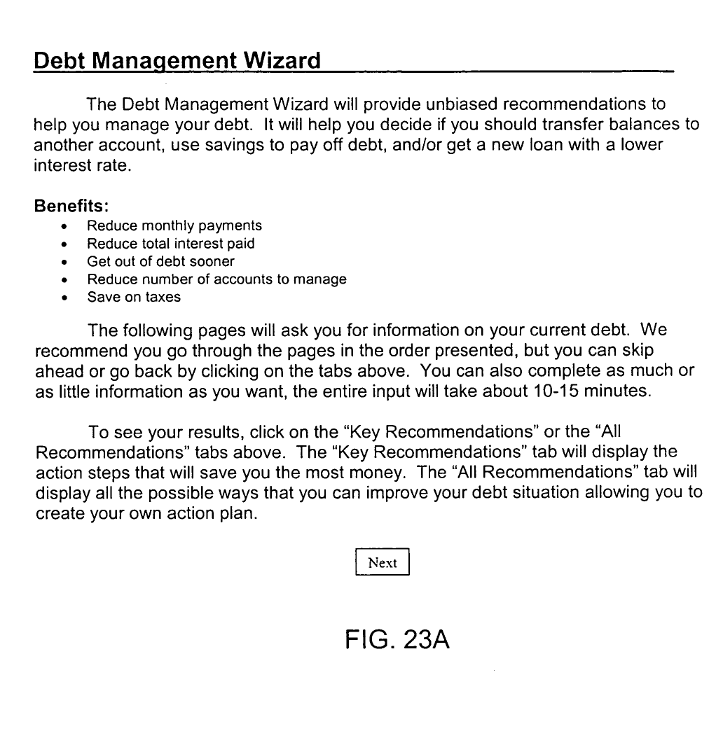

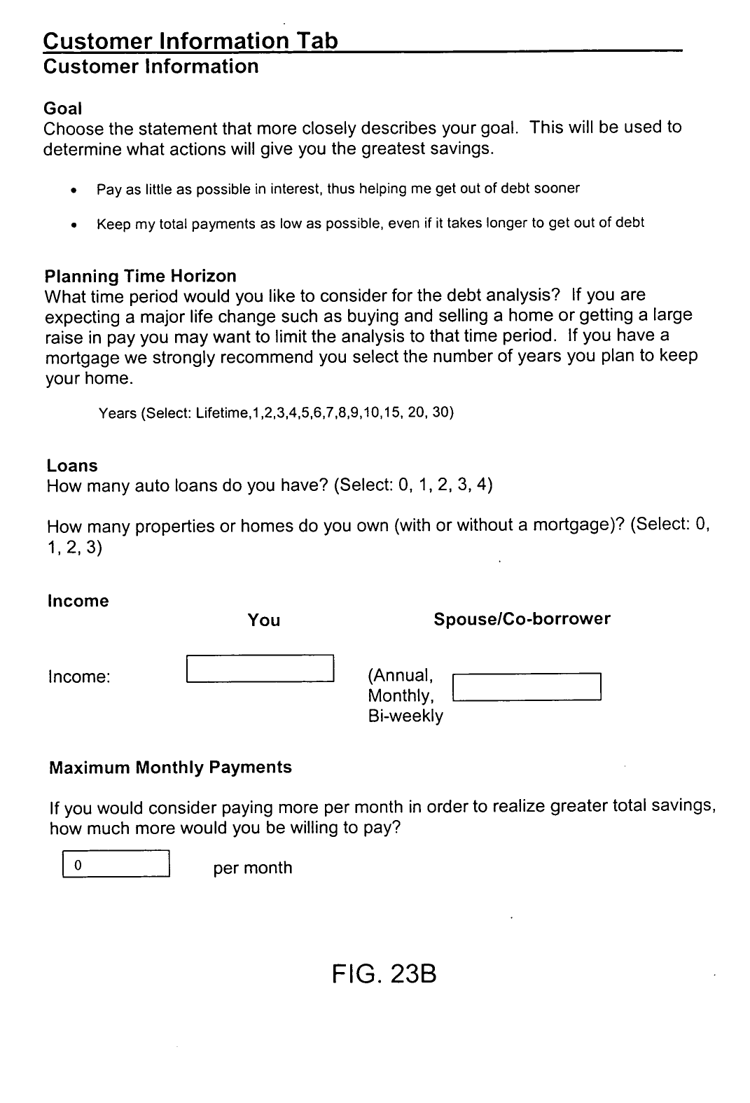

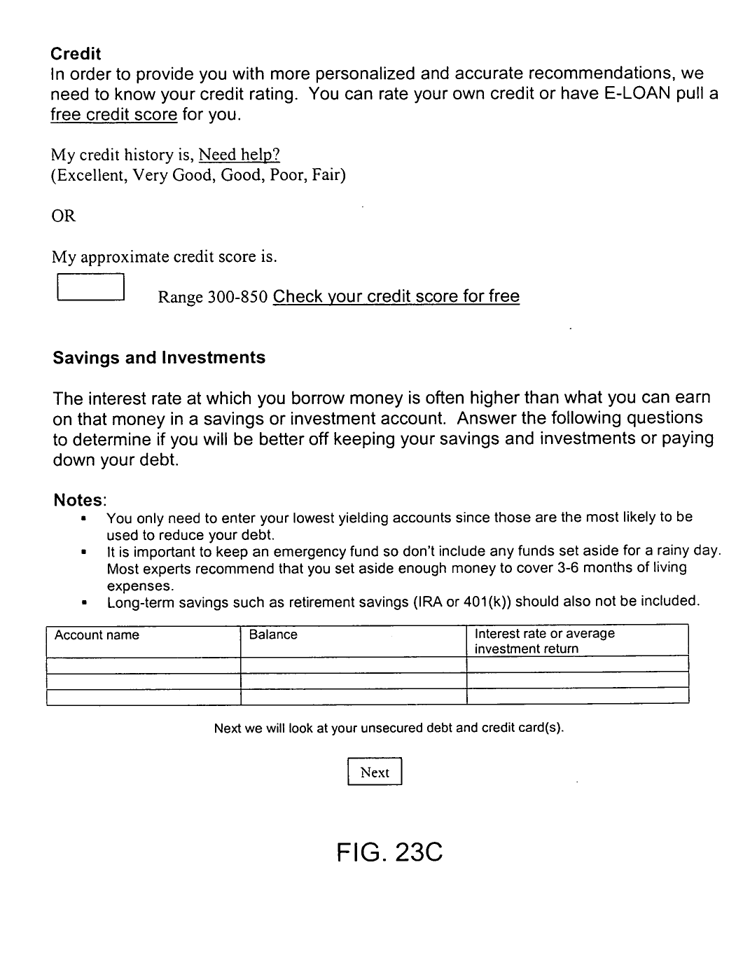

Referring now to FIG. 22, a flowchart is presented that illustrates the steps performed by debt management system 2200 in recommending the optimal debt management actions to a specific user. FIG. 23A illustrates a sample home page of debt management system host 111. This page is presented on a user's terminal screen once the user has accessed the host web site and requested debt management counseling. As previously indicated, the home page is the gateway that enables users to access the functions of the system 2200. Once the user indicates enters the system 2200, a user input form 2205 is displayed, such as the web pages illustrated in FIGS. 23B and 23C. The user input form 2205 requests a preferred debt management approach from a user. For example, two illustrated approaches include “Pay as little as possible in interest, thus helping me get out of debt sooner” and “Keep my total payments as low as possible, even if it takes longer to get out of debt” as shown in FIG. 23B. The user input form 2205 also requests time horizon information, types of loans currently held by the user, available income information, credit rating information, and available savings and investment information.

In one embodiment, the debt management system 2200 may optimize the user selections according to one of the following optimization objectives: get out of debt as soon as possible using any payment savings to pay down other debt, get out of debt as soon as possible and keep any realized payment savings, minimize after-tax interest costs, and minimize total payments.

The collection of this user-selected optimization information helps to determine a user specific debt management methodology. The debt management methodology, in turn, helps to define a series of debt optimization criteria to apply to the user's situation. Exemplary debt management solutions available to the debt management system 2200 include cash-out mortgage refinance, rate and term mortgage refinance, home equity loans and lines of credit, auto loan refinance, balance transfer, money from savings, paying the minimum on one debt in order to apply the payment to another debt, and making an extra payment every month. If cash-out mortgage refinance is selected, then the debt management system 2200 will display whether or not the user can save by refinancing their current first mortgage and taking cash-out to pay off other loans. For example, the system 2200 might suggest that a second mortgage can be paid off, in addition to other non-mortgage loans that are to be paid off. The system 2200 may suggest that a home equity can be used as the only mortgage. If the debt management system 2200 selects rate and term mortgage refinance then the debt management system 2200 will display whether or not the user can save by refinancing their first mortgage or first and second with a new first mortgage. In one embodiment, this option does not allow money to be taken out to pay off other debts. In one embodiment, a home equity loan can be used as the only mortgage. If home equity loans and lines of credit are selected, then the debt management system 2200 will display whether or not the user can save by taking out a home equity loan or line of credit. In one embodiment, the system 2200 will identify whether or not a current home equity loan must be paid off with a portion of the new loan. In one embodiment, other debt beside a current home equity can be paid off, but does not have to be paid off in order to qualify. In one embodiment, this option does not allow mortgage debt to be paid off. If auto loan refinance is selected, then the debt management system 2200 will display whether or not the user can save by refinancing their auto loan with a new auto loan. If balance transfer is selected, then the debt management system 2200 will display whether or not the user can save by transferring a balance from one debt to another debt account. In one embodiment, accounts that can receive debt include home equity lines of credit, credit cards, and personal lines of credit, as long as there is credit available on the respective receiving account. If money from savings is selected, then the debt management system 2200 will display whether or not the user can save by taking money out of a lower-yielding savings accounts and using it to pay down debt. If paying the minimum on one debt in order to apply the payment to another debt is selected, then the debt management system 2200 will display whether or not the user can save by making the minimum payment on one debt and applying the difference between the current and minimum payment to another debt. If the user indicated that they could afford making an extra payment every month, then the debt management system 2200 will display how this payment should be applied. For example, applying this payment to the highest interest after-tax rate debt until it is paid off and then paying down the next highest interest rate debt results in the highest after-tax debt being reduced and, hopefully, paid off quickly.

Upon adopting a set of user-selected debt optimization criteria for a specific user, the debt management system 2200 collects, through a series of input forms (2205, 2210, 2225, and 2235), the details of all of the user's existing debt. The user can enter information for his/her mortgages, home equity loans, auto loans, credit cards/personal lines of credit, unsecured debt loans, and savings accounts.

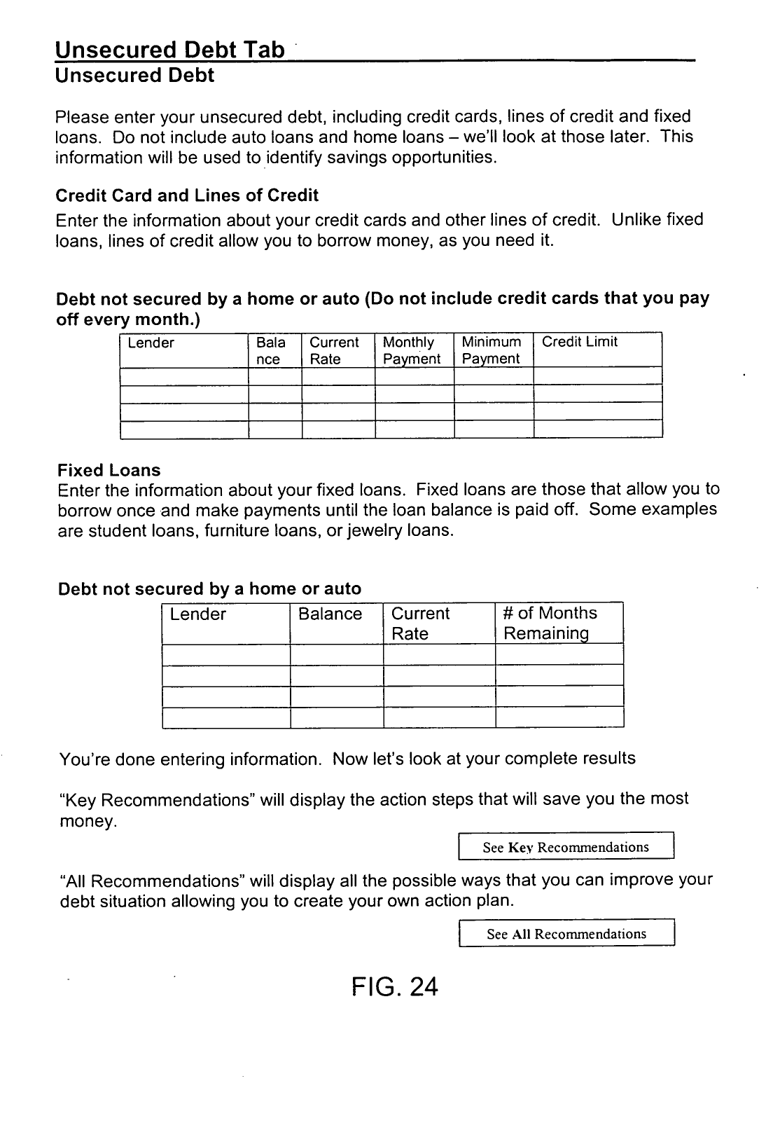

The exemplary web screen in FIG. 24 is presented to users to collect unsecured debt information 2210 including credit cards, other lines of credit, and fixed unsecured loans. The unsecured debt information with regards to credit cards and other lines of credit includes balances, current rate information, monthly payment, minimum payment, and credit limit information. Fixed loan information includes balances, current rate, and remaining months.

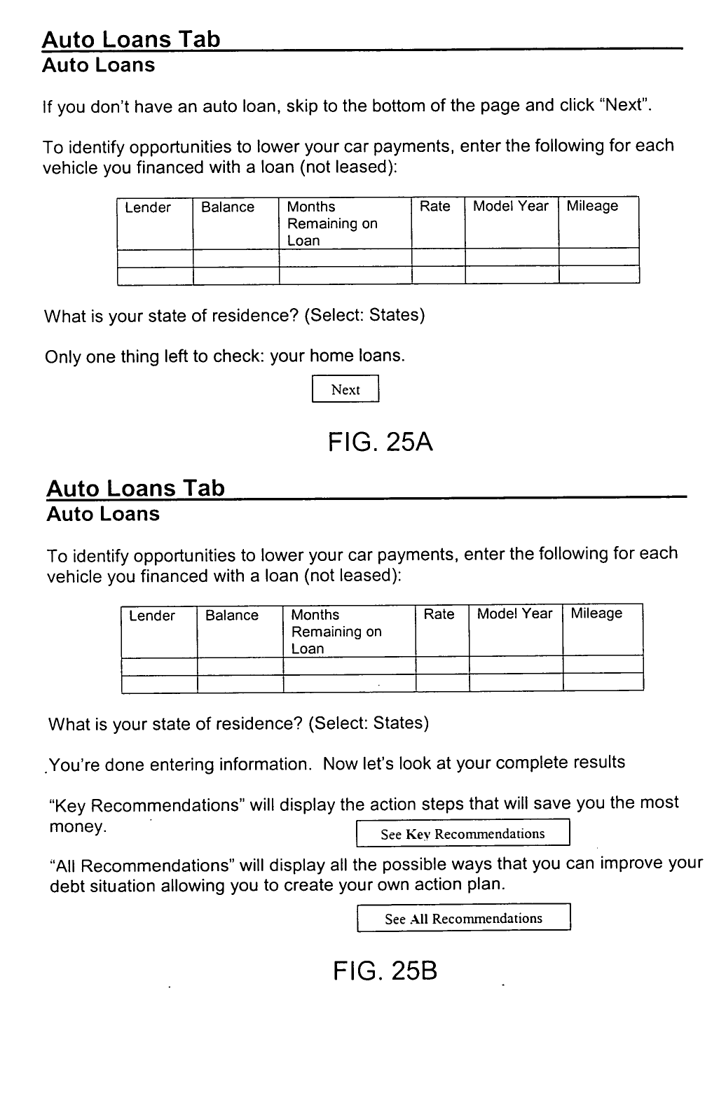

Upon determining that the user has an auto loan in query block 2220, the system 2200 collects auto loan information 2225 from the user. One of the exemplary web screens, as shown in FIGS. 25A and 25B, is presented to the user to collect auto loan information and identify opportunities to lower the user's car loan payment. The requested vehicle loan information includes the lender, balance, months remaining, interest rate, model year, and mileage of the vehicle. The last two categories allow the system 2200 to eliminate vehicles that have mileage greater than 75,000 or are more than seven years old. Otherwise, the system 2200 analyzes available vehicle refinance options by calculating the payment and interest for a new auto loan over the desired loan period. FIG. 25A is presented to the user if the user has a property loan and FIG. 25B is presented if there are no property loans to be considered by the system 2200.

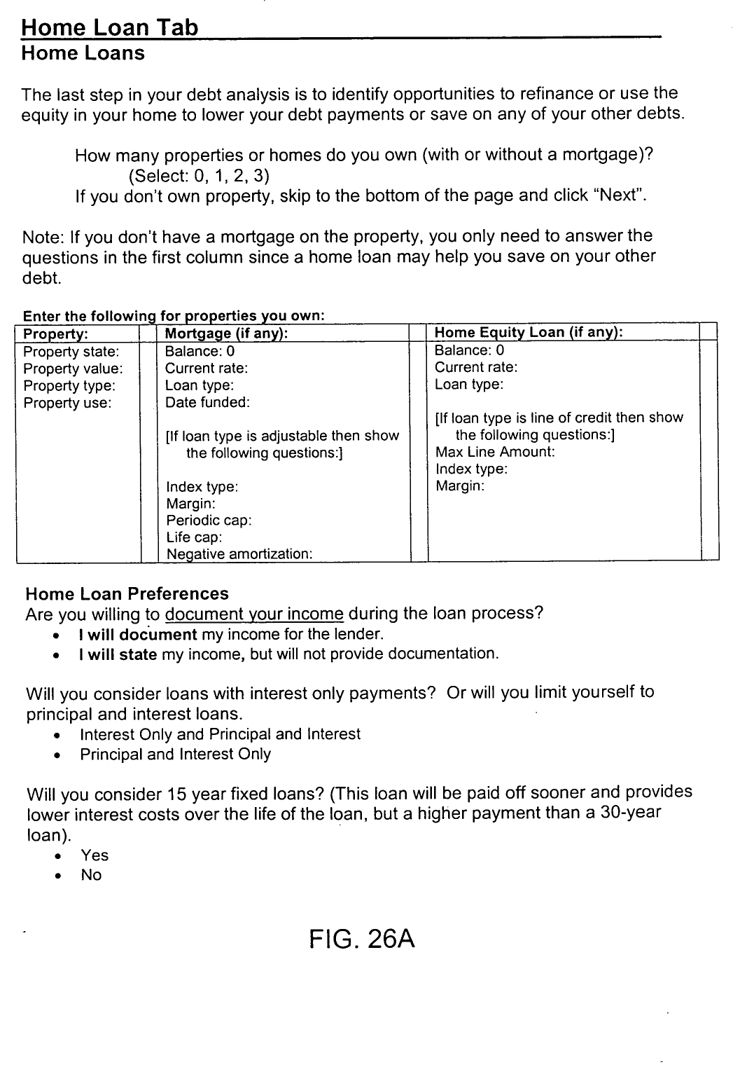

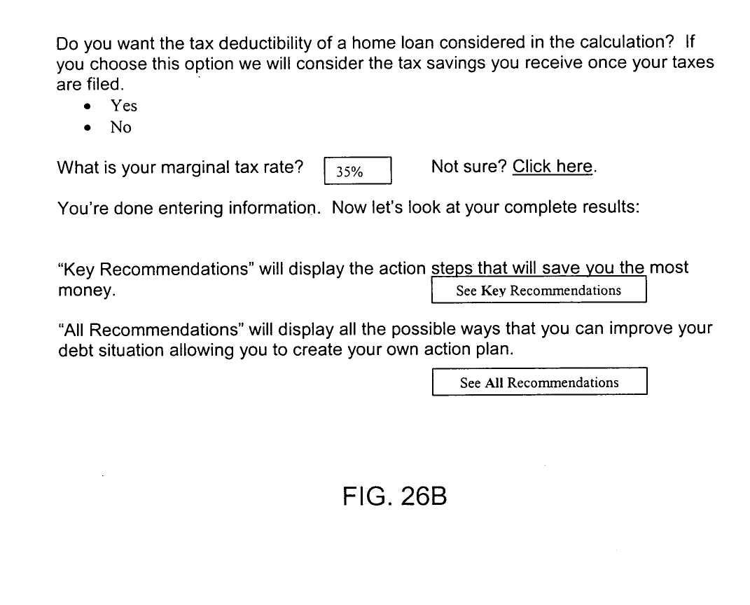

Upon determining that the user has a property loan in query block 2230, the system 2200 collects property loan information 2235 from the user. The exemplary web screen, as shown in FIGS. 26A and 26B, is presented to the user to collect property loan information and identify opportunities to lower mortgage payments. The requested mortgage information includes a description of the property, balance, current rate, loan type, and corresponding home equity information.

Once the debt management system 2200 has collected the relevant information, the debt management system takes optimization objective criteria and applies the criteria to the user inputs to find the lowest cost action(s) available to the user. The system 2200 generates recommended action(s) to be displayed on two results pages. One results page displays the key recommended package of actions 2245 that will save the user the most money. The second results page displays all the potential recommended actions 2260 the user can take that would save them money.

In considering what actions to recommend, the debt management system will check the current financial situation of the user against all possibilities of new mortgage, home equity, auto loans, and savings to see which options will save the user money. The recommended options are selected according to which options will save the user the most money based upon the users selected optimization criteria. Among other calculations, the debt management system considers refinancing an existing mortgage, refinancing an existing mortgage and taking additional cash to pay off other loans (including another mortgage), refinancing a house with no mortgage to get cash-out, refinancing an auto loan with a new auto loan, getting a new home equity loan or line of credit with additional cash, refinancing a home equity loan or line of credit, transferring balances between lines of credit and credit cards, and using savings to pay-off existing loans, among other considerations.

In one embodiment, the key recommendations provide the combination of actions that together will save the user the most money (according to the user's optimization objective). In comparison, the all recommendations provide at least the best action item recommended for each type of savings listed above regardless of whether or not they are mutually exclusive. The user can pick and choose those actions they want to take and, as they select options, those that are no longer relevant or available are no longer shown.

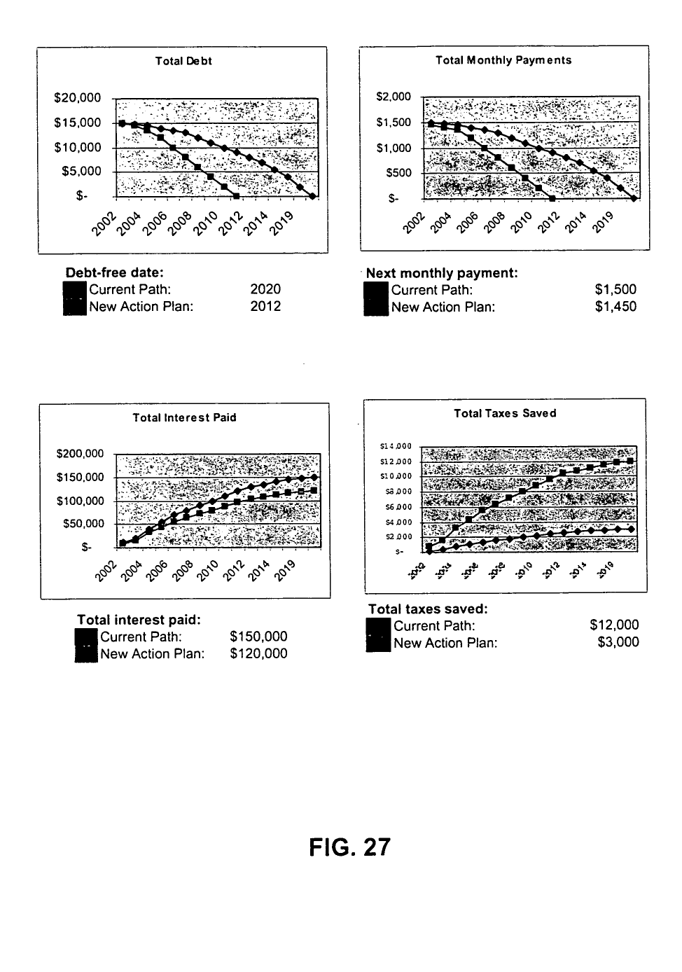

In both recommendation cases, the associated savings and charts (see, e.g., FIG. 27) showing changes in their payments, tax savings, interest paid, and total debt over time are updated in real-time to reflect the selected recommended action items. If a user wants details on the recommended loan they can click thru to the Loan Advisor output to see the loan details and, if desired, see alternative loans or apply for the loan.

In generating recommendations for the user, the system 2200 determines ways that the user can save money. Based upon the user's desires, possible solutions are presented to the user. Exemplary recommendations include cash-out mortgage refinance, rate and term mortgage refinance, home equity loan (possibly including refinancing an existing home equity loan), auto refinance, transfer of balances between accounts, using savings to pay off debt, making the minimum payment on one debt in order to apply a greater payment to another debt, and paying extra every month, to name a few.

The debt management system 2200 does a real-time rate search using the user's credit score or estimated credit history, as well as other qualifying underwriting criteria (i.e., minimum and maximum loan amounts and loan-to-value ratios, debt-to-income ratios, and property type, use and location). The debt management system 2200 then uses all this information to calculate and compare the monthly payments and interest costs of every qualifying loan. In one embodiment, real time rates are only displayed to the user if a home or auto loan is recommended.

Moreover, the various recommendations may be saved and monitored by the system 2200 for future changes in available options. As such, the recommendations of the debt management system 2200 provide adaptive dynamic recommendations to the user based on the user-selected debt management criteria. The information the user enters will be stored in a user account so that the user can return often and view current recommendations. This account can be linked to an application or credit report so that the user's debts and credit score are automatically pre-populated. This account can also be linked to a credit monitoring service so that the user's debts and credit score are automatically updated on a monthly basis.

The system 2200 is integrated into credit score services thereby allowing a user to pull his/her credit score and report in real time. Upon returning after the initial session, the credit score and debt information is automatically captured and imported into the system 2200 so that a user can avoid entering information that can already be found on the credit report. In one embodiment, the user may receive an on-going credit monitoring service, such that the user's credit information is automatically updated each month, for example.

In one embodiment, the system 2200 can be used on a one-time basis or on an on-going basis. All the information entered is saved in a user-selected password-protected account so that the user can log back in at any time, update his/her information, and rerun the recommendations. Users who choose to use the system 2200 on an on-going basis will automatically receive periodic emails with updated recommendations that reflect the then current rates and, in conjunction with a credit monitoring service, potentially credit score, debts, home, and auto valuations.

The debt management system's rate search contains the underwriting guidelines for every available loan product. This includes, for example, the loan amount, credit rating, loan-to-value, debt-to-income, combined loan-to-value, property type, property use, income documentation, and state. Rates are loaded at least once daily so real-time information is used for the analysis. The new loan offered to the user must meet the product underwriting guidelines and the rate will reflect these guidelines as well. The debt management system forecasts future loan rates on adjustable rate loans by forecasting the future value of the underlying loan index (i.e., treasury rates). A rate projection curve is used for mortgage rates and an adjustment of the mortgage curve that is used for home equity lines of credit. Both curves depend on current bond prices for short-term and longer-term bonds.

The available loan products that the user eventually sees recommended on the results pages are the loan products that the user can apply for using an online application process. For example, clicking the apply button next to one of the recommendations will link the user to the mortgage, home equity, or auto application with the appropriate information automatically passed through and into the loan application.

In one embodiment, when requesting input from the user, the debt management system must verify that the necessary information has been received from the user. As such, the entry validation specified for each input page should be activated and checked upon any form action. If there is a problem with the data the user entered, then the system should return the user to reenter the necessary data, because the user will not be able to move forward to the next web page, nor will the user be able to click on any tab to artificially move forward.

The debt management system will provide unbiased recommendations to help a user manage debt. It will helps a user decide if balances should be transferred to another debt account, savings should be used to pay off debt, and/or a new loan should be obtained with a lower interest rate. Some of the benefits of the recommendations from the debt management system include reduced monthly payments, reduced total interest paid, getting out of debt sooner, reducing the number of accounts to manage, and saving on taxes.

User information includes debt management optimization objective or goal, planning time horizon, loan types, income, credit ratings, and potential additional payments. Two exemplary debt management optimization goals include “Pay as little as possible in interest, thus helping me get out of debt sooner” and “Keep my total payments as low as possible, even if it takes longer to get out of debt.” Other debt management optimization goals may also be implemented in the debt management system.

Under the “Pay as little as possible in interest, thus helping me get out of debt sooner” optimization option, the debt management system would seek to minimize interest cost, but does not use the payment of a loan that is paid off to pay off the principal of another loan. The process seeking to minimize interest includes after-tax interest, PMI, and closing costs. The payments will continue to fall as each loan is paid off. The beginning payment should not exceed the sum of the current payments plus the extra payment, however, the beginning payment does not have to equal the sum of current payments plus the extra payment.

Under the “Keep my total payments as low as possible, even if it takes longer to get out of debt” optimization option, the debt management system seeks to minimize total payments over the hold period. Total payments includes principal, interest, PMI, and closing costs. The tax-deductible effects of various lending instruments may or may not be included based on the user input. The beginning payment should not exceed the sum of the current payments plus the extra payment, however, the beginning payment does not have to equal the sum of current payments plus the extra payment.

Other factors may also be considered in determining the key recommendations for debt management. For example, whether or not the user would be willing to consider loans with interest only payments? In one embodiment, even if “interest only” loan options are considered, they are only displayed on the key recommendations page if the loan best meets the optimization goal.

The present invention may be embodied in other specific forms without departing from its spirit or important characteristics. The described embodiments are to be considered in all respects only as illustrative and not restrictive. Therefore, the scope of the invention is indicated by the appended claims rather than by the foregoing description. All changes that come within the meaning and range of equivalency of the claims are to be embraced within their scope.

1. A method of recommending debt management actions to a user for improving a debt situation of the user, which comprises:
requesting, from the user, debt management optimization criteria to be used in evaluating potential debt management actions to be recommended to the user;
receiving at least one debt management optimization criteria selected by the user; and
communicating at least one recommended debt management action to the user based upon the user-selected debt management optimization criteria.

2. The method according to claim 1, which further comprises carrying out the communicating step by providing the user with dynamic adaptive recommendations based upon economic market conditions.

3. The method according to claim 1, which further comprises carrying out the communicating step by providing the user with dynamic adaptive recommendations based upon current economic market conditions.

4. The method according to claim 1, which further comprises carrying out the communicating step by providing the user with dynamic adaptive recommendations based upon historic economic market conditions.

5. A method of recommending debt management actions to a user based upon a preferred debt management methodology, the method comprising:
receiving a user-selected preferred debt management methodology;
generating debt optimization criteria dependent upon the received user-selected preferred debt management methodology; and
selecting at least one debt management action based upon the debt optimization criteria.

6. The method according to claim 5, which further comprises transmitting the selected at least one debt management action to the user as a recommendation for improving a debt situation of the user.

7. The method according to claim 6, which further comprises evaluating potential debt management actions to be taken by the user based upon the at least one debt management action selected.

8. The method according to claim 5, which further comprises requesting the user to selected a preferred debt management methodology from a set of debt management methodologies.

9. A machine-readable medium having instructions stored thereon for execution by a processor to perform a method of recommending debt management actions to a user for improving a debt situation of the user, which comprises:
requesting from the user debt management optimization criteria to be used in evaluating potential debt management actions to be recommended to the user;
receiving at least one debt management optimization criteria selected by the user; and
communicating at least one recommended debt management action to the user based upon the user-selected debt management optimization criteria.

10. The method according to claim 9, which further comprises carrying out the communicating step by providing the user with dynamic adaptive recommendations based upon economic market conditions.

11. The method according to claim 9, which further comprises carrying out the communicating step by providing the user with dynamic adaptive recommendations based upon current economic market conditions.

12. The method according to claim 9, which further comprises carrying out the communicating step by providing the user with dynamic adaptive recommendations based upon historic economic market conditions.

13. A machine readable medium having instructions stored thereon for execution by a processor to perform a method of recommending debt management actions to a user based upon a preferred debt management methodology, the method comprising:
receiving a user-selected preferred debt management methodology;
generating debt optimization criteria dependent upon the received user-selected preferred debt management methodology; and
selecting at least one debt management action based upon the debt optimization criteria.

14. The method according to claim 13, which further comprises transmitting the selected at least one debt management action to the user as a recommendation for improving a debt situation of the user.

15. The method according to claim 14, which further comprises evaluating potential debt management actions to be taken by the user based upon the at least one debt management action selected.

16. The method according to claim 13, which further comprises requesting the user to selected a preferred debt management methodology from a set of debt management methodologies.

17. A system for recommending debt management actions to a user associated with a respective user station, the system comprising:
a communications network;
a plurality of user stations selectively connected to the communications network, each of said user stations being associated with a respective display terminal and being configured to display a page of information; and
a server operatively connected to the communications network, said server being configured to transmit a request for user-selected debt management optimization criteria; and
upon receiving from one of said user stations a transmittal containing at least one of said user-selected debt management optimization criteria, said server being configured to recommend, to a user associated with said one user station, at least one debt management action for the user to take dependent upon said received user-selected debt management optimization criteria.

18. The system according to claim 17, further comprising an information storage facility operatively connected to said communications network, said information storage facility having a database with searchable loan-related input parameters, said server being configured to incorporate said searchable loan-related input parameters into said recommendation of said at least one debt management action received by said one user station.

19. The system according to claim 18, wherein said server automatically monitors said information storage facility for changes to said database and, upon detection of at least one of said changes, dynamically adapts said at least one debt management action and transmits said dynamically adapted recommendation to said one user station.

20. The system according to claim 17, wherein said display terminal is configured to display an Internet web page.

21. In a communications network selectively connected to a plurality of user stations, each of the user stations being associated with a respective display terminal and being configured to display a page of information, a system for recommending debt management actions to a user associated with a respective one of the user stations, the system comprising:
a server operatively connected to the communications network, said server being configured to transmit a request for user-selected debt management optimization criteria; and
upon receiving from one of the user stations a transmittal containing at least one of said user-selected debt management optimization criteria, said server being configured to recommend, to a user associated with the one user station, at least one debt management action for the user to take dependent upon said received user-selected debt management optimization criteria.

22. The system according to claim 21, further comprising an information storage facility operatively connected to the communications network, said information storage facility having a database with searchable loan-related input parameters, said server being configured to incorporate said searchable loan-related input parameters into said recommendation of said at least one debt management action received by the one user station.

23. The system according to claim 22, wherein said server automatically monitors said information storage facility for changes to said database and, upon detection of at least one of said changes, dynamically adapts said at least one debt management action and transmits said dynamically adapted recommendation to the one user station.

24. The system according to claim 21, wherein the display terminal is configured to display an Internet web page.
